(19) United States
(12) Patent Application Publication
(10) Pub. No.: US 2014/0295261 A1
(43) Pub. Date: Oct. 2, 2014

(54) ELECTROCHEMICAL DEVICE AND METHOD FOR SUPPRESSING DETERIORATION OF THE ELECTROCHEMICAL DEVICE

(71) Applicant: SEMICONDUCTOR ENERGY LABORATORY CO., LTD., Atsugi-shi (JP)

(72) Inventors: Hiroyuki MIYAKE, Atsugi (JP); Teppei OGUNI, Atsugi (JP); Tatsuya TAKAHASHI, Tokyo (JP); Takuya MIWA, Atsugi (JP); Aya HITOTSUYANAGI, Atsugi (JP)

(73) Assignee: SEMICONDUCTOR ENERGY LABORATORY CO., LTD., Atsugi-shi (JP)

(21) Appl. No.: 14/220,354

(22) Filed: Mar. 20, 2014

(30) Foreign Application Priority Data
Mar. 28, 2013 (JP) 2013-069618

(51) Int. Cl. H01M 10/0566; H01M 4/587; H01M 10/052

(52) U.S. Cl. CPC H01M 10/0566; H01M 10/052; H01M 4/587; H01M 2300/0037
USPC 429/199; 429/188

(57) ABSTRACT

An object is to provide an electrochemical device in which lithium deposition and reduction in battery capacity can be inhibited even when the concentration of a lithium salt in an electrolytic solution is lower than 1.0 M. Lithium deposition can be inhibited and lithium whiskers can be dissolved by applying an inversion pulse current for a short time more than once in a charging period of a secondary battery which deteriorates. By applying the inversion pulse current more than once, deterioration of a lithium-ion secondary battery due to repeated charging can be suppressed even when it is a secondary battery in which the concentration of a lithium salt in an electrolytic solution is lower than 1.0 M and therefore lithium is easily deposited.

### BACKGROUND OF THE INVENTION

1. Field of the Invention

The present invention relates to an electrochemical device and a method for suppressing deterioration of the electrochemical device.

Note that an electrochemical device in this specification generally means a device that utilizes an electrochemical phenomenon, specifically, a lithium-ion secondary battery or the like.

2. Description of the Related Art

A lithium-ion secondary battery, which is one of electrochemical devices, is used in a variety of applications including a power source of a mobile phone, a fixed power source of a residential power storage system, power storage equipment of a power generation facility, such as a solar cell, and the like. Characteristics such as high energy density, excellent cycle characteristics, safety under various operating environments, and long-term reliability are necessary for the lithium-ion secondary battery.

In addition, the lithium-ion secondary battery includes at least a positive electrode, a negative electrode, and an electrolytic solution (Patent Document 1).

### REFERENCE

### Patent Document

[Patent Document] Japanese Published Patent Application No. 2012-009418

### SUMMARY OF THE INVENTION

Repeated charging or discharging gradually reduces the battery capacity of a lithium-ion secondary battery from its initial value.

An analysis of a lithium-ion secondary battery shows that lithium deposited on a surface of a negative electrode is a cause of the reduction in battery capacity. The lithium deposited in the negative electrode tends to be observed particularly when the concentration of a lithium salt in an electrolytic solution is lower than 1.0 M.

Although making it easy for lithium to be deposited in a negative electrode, a lithium salt included in an electrolytic solution at a concentration of lower than 1.0 M allows a reduction in the amount of solute dissolved in the electrolytic solution and a decrease in the viscosity of the electrolytic solution, and thus gains a big advantage.

However, lithium deposited in a negative electrode also causes a positive electrode and a negative electrode to be short-circuited. The short-circuited electrodes cause heat generation or ignition, leading to a decrease in the safety of a lithium-ion secondary battery.

Further, lithium deposited in a negative electrode separates from the negative electrode in some cases. Separation of lithium reduces battery capacity.

In view of the above, an object of one embodiment of the present invention is to provide an electrochemical device in which deposition of lithium can be suppressed even when the concentration of a lithium salt in an electrolytic solution is lower than 1.0 M. Another object of one embodiment of the present invention is to provide an electrochemical device in which a positive electrode and a negative electrode can be inhibited from being short-circuited even when the concentration of a lithium salt in an electrolytic solution is lower than 1.0 M. Another object of one embodiment of the present invention is to provide an electrochemical device in which separation of lithium in a negative electrode can be inhibited even when the concentration of a lithium salt in an electrolytic solution is lower than 1.0 M.

Note that the descriptions of these objects do not disturb the existence of other objects. In one embodiment of the present invention, there is no need to achieve all the objects. Other objects will be apparent from and can be derived from the description of the specification, the drawings, the claims, and the like.

One embodiment of the present invention is a secondary battery including a lithium salt in an electrolytic solution at a concentration of lower than 1.0 M. In charging the secondary battery, a charging current that flows from a negative electrode to a positive electrode and an inversion pulse current that flows in a direction opposite to that of the charging current are alternately applied repeatedly to the positive electrode and the negative electrode.

In one embodiment of the present invention with such a structure, lithium deposition can be inhibited and lithium whiskers can be dissolved by applying an inversion pulse current for a short time more than once in a charging period of the secondary battery which deteriorates. By applying the inversion pulse current more than once, deterioration of a lithium-ion secondary battery due to repeated charging can be suppressed even when it is a secondary battery in which the concentration of a lithium salt in an electrolytic solution is lower than 1.0 M and therefore lithium is easily deposited. This means that a secondary battery capable of inhibiting a rapid reduction in battery capacity can be provided without making the structure of the secondary battery complicated.

Note that an inversion pulse current is a current that flows in a direction opposite to the direction of a charging current. In charging a secondary battery, the charging current flows from a charger to a positive electrode, flows from the positive electrode to a negative electrode in the secondary battery, and flows from the negative electrode to the charger. In other words, in charging the secondary battery, the inversion pulse current is a current that flows from the negative electrode to the positive electrode inside the secondary battery, and flows from the positive electrode to the negative electrode outside the secondary battery. In discharging, the inversion pulse current is a current that flows in the same direction as that of a discharging current.

One embodiment of the present invention is an electrochemical device including a first electrode, a second electrode, and an electrolytic solution in which a lithium salt is dissolved. The concentration of the lithium salt in the electrolytic solution is lower than 1.0 M. To the first electrode and the second electrode, a first current that flows from the second electrode to the first electrode and a second current that flows in a direction opposite to a direction of the first current are alternately applied repeatedly. A period in which the second current is applied is shorter than a period in which the first current is applied.

In the electrochemical device of one embodiment of the present invention, the lithium salt is preferably lithium hexafluorophosphate.

In the electrochemical device of one embodiment of the present invention, the electrolytic solution is preferably ethylene carbonate and diethyl carbonate mixed in a volume ratio of 3:7.

In the electrochemical device of one embodiment of the present invention, the first electrode preferably includes lithium iron phosphate as an active material.

In the electrochemical device of one embodiment of the present invention, the second electrode preferably includes graphite as an active material.

In the electrochemical device of one embodiment of the present invention, the concentration of the lithium salt in the electrolytic solution is preferably higher than 0.25 M and lower than 1.0 M.

In addition, another embodiment of the present invention is a method for suppressing deterioration of the above-described electrochemical device by applying the second current more than once to the electrochemical device.

One embodiment of the present invention makes it possible to inhibit lithium deposition and regularly dissolve lithium deposited on a negative electrode surface. Thus, even when the concentration of the lithium salt in the electrolytic solution is lower than 1.0 M, the positive electrode and the negative electrode can be inhibited from being short-circuited and separation of lithium in the negative electrode can be inhibited. Further, in one embodiment of the present invention, the concentration of the lithium salt in the electrolytic solution can be lowered to a level at which lithium is deposited in the negative electrode; therefore, the amount of solute dissolved in the electrolytic solution can be reduced and the viscosity of the electrolytic solution can be decreased.

### BRIEF DESCRIPTION OF THE DRAWINGS

FIGS. 1A and 1B are schematic diagrams illustrating an example of a method for applying an inversion pulse current.

FIG. 2 is a schematic diagram illustrating an example of an influence of an inversion pulse current.

FIG. 3 is a conceptual diagram of the state of charging a lithium-ion secondary battery.

FIG. 4 is a conceptual diagram of the state of discharging the lithium-ion secondary battery.

FIG. 5 is a diagram illustrating the relationship between the potentials of a positive electrode and a negative electrode.

FIG. 6 is an image of lithium whiskers deposited on a surface of graphite.

FIG. 7A is a plane image and FIG. 7B is a cross-sectional TEM image of lithium whiskers deposited on a surface of graphite.

FIG. 8A is a longitudinal cross-sectional diagram of an electrode, and FIG. 8B is an enlarged longitudinal cross-sectional diagram of an active material layer.

FIG. 9 is a cross-sectional diagram of a modification example of the electrode.

FIGS. 10A and 10B illustrate secondary batteries.

FIGS. 11A and 11B illustrate a secondary battery.

FIGS. 12A to 12C illustrate a secondary battery.

FIGS. 13A to 13C illustrate an electrical device.

FIGS. 14A and 14B illustrate an electrical device.

FIG. 15 is a schematic diagram illustrating a structure of an evaluation cell and methods for charging and discharging the evaluation cell.

FIGS. 16A and 16B are graphs each showing the relationship between battery capacity and a cell voltage of an evaluation cell (0.25 M).

FIGS. 17A and 17B are graphs each showing the relationship between battery capacity and a cell voltage of an evaluation cell (0.5 M).

FIGS. 18A and 18B are graphs each showing the relationship between battery capacity and a cell voltage of an evaluation cell (1.0 M).

FIG. 19 is a graph showing the relationship between battery capacity and a cell voltage of an evaluation cell (2.0 M).

FIGS. 20A and 20B are each an image of a surface of graphite in an evaluation cell (0.25 M).

FIGS. 21A and 21B are each an image of a surface of graphite in an evaluation cell (0.5 M).

FIGS. 22A and 22B are each an image of a surface of graphite in an evaluation cell (1.0 M).

FIG. 23 is an image of a surface of graphite in an evaluation cell (2.0 M).

FIGS. 24A and 24B are schematic diagrams illustrating the principle of deposition of lithium whiskers on a surface of graphite.

FIG. 25 is a schematic diagram illustrating intercalation of lithium ions into particulate graphite.

FIG. 26 is schematic diagrams illustrating the principle of deposition of lithium whiskers on a surface of graphite.

FIGS. 27A and 27B are images of lithium whiskers deposited on a surface of graphite.

### DETAILED DESCRIPTION OF THE INVENTION

Embodiments and an example are described below with reference to drawings. However, the embodiments and the example can be implemented with various modes. It is easily understood by those skilled in the art that modes and details can be changed in various ways without departing from the spirit and scope of the present invention. Thus, the present invention should not be interpreted as being limited to the following description of the embodiments and the example. Note that in structures of the present invention described below, reference numerals denoting the same portions are used in common in different drawings.

In the drawings, the size, the layer thickness, or the region is exaggerated for clarity in some cases. Therefore, the embodiments and the example of the present invention are not limited to such a scale. Note that the drawings are schematic views showing ideal examples, and the embodiments and the example of the present invention are not limited to shapes or values shown in the drawings. For example, the following can be included: variation in signal, voltage, or current due to noise or difference in timing.

Note that in this specification, ordinal numbers such as “first”, “second”, and “third” are used in order to avoid confusion among components, and thus do not limit the number of the components.

### Embodiment 1

### <Inversion Pulse Current>

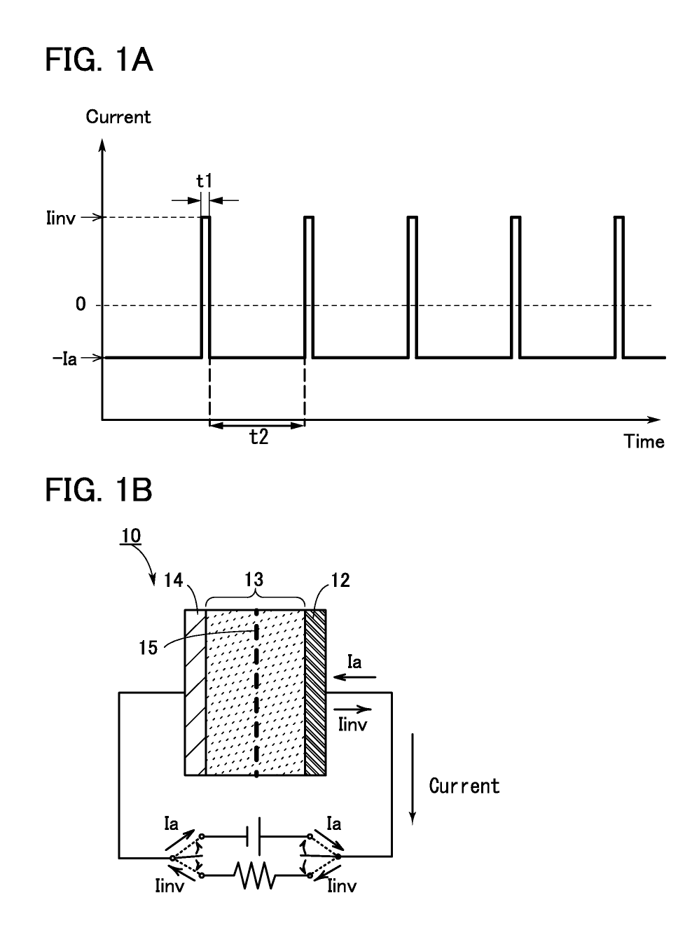

Description is given of an inversion pulse current with reference to FIGS. 1A and 1B.

FIG. 1A schematically illustrates a change over time in a current that flows from a positive electrode to a negative electrode of a secondary battery in charging.

A current Ia (also referred to as a first current) illustrated in FIG. 1A is a charging current in charging a secondary battery 10. In this embodiment, the current Ia is a constant current for simplicity; however, the amount thereof may be changed as appropriate depending on the condition of the secondary battery.

An inversion pulse current Iinv (also referred to as a second current) illustrated in FIG. 1A is a discharging current in charging the secondary battery 10. Although the inversion pulse current Iinv is a constant current here, the amount thereof may be changed as appropriate.

In this embodiment, the direction in which the inversion pulse current Iinv flows is defined as the positive direction of current. In this case, outside the secondary battery, the direction from a positive electrode to a negative electrode is defined as the positive direction of current. The current Ia and the inversion pulse current Iinv each have a predetermined amount.

According to the above definition, a current that flows in a direction opposite to the positive direction has a negative value. For example, the charging current is represented by −Ia in FIG. 1A because the charging current flows in the direction opposite to the positive direction. Further, the inversion pulse current is represented by Iinv in FIG. 1A because the inversion pulse current flows in the positive direction.

FIG. 1B illustrates the charging current Ia and the inversion pulse current Iinv applied to the secondary battery 10 in charging.

The secondary battery 10 in FIG. 1B includes a positive electrode (also referred to as a first electrode) 12, an electrolytic solution 13, a negative electrode (also referred to as a second electrode) 14, and a separator 15, for example.

In FIG. 1B, the directions in which the charging current Ia and the inversion pulse current Iinv flow in charging the secondary battery 10 are indicated by arrows.

The charging current Ia is applied to the negative electrode 14 or the positive electrode 12 to flow from the negative electrode 14 to the positive electrode 12 outside the secondary battery 10 and flow from the positive electrode 12 to the negative electrode 14 inside the secondary battery 10. The inversion pulse current Iinv is applied to the negative electrode 14 or the positive electrode 12 to flow from the positive electrode 12 to the negative electrode 14 outside the secondary battery 10 and flow from the negative electrode 14 to the positive electrode 12 inside the secondary battery 10. In the case of FIG. 1B, the current Ia is applied to the positive electrode 12 from outside of the secondary battery 10, and the inversion pulse current Iinv is applied to outside of the secondary battery 10 from the positive electrode 12.

Note that the charging current Ia should be applied by controlling a switch connected to a charging circuit, such as a current generator or a voltage generator that applies current or voltage, provided outside the secondary battery 10. The inversion pulse current Iinv should be applied by controlling a switch connected to a load provided outside the secondary battery 10.

The charging current Ia and the inversion pulse current Iinv illustrated in FIG. 1B are applied in such a manner that the inversion pulse current Iinv is applied during an interval or intervals between applications of the charging current Ia as illustrated in FIG. 1A. Note that one period t1 in which the inversion pulse current Iinv is applied is shorter than one period t2 in which the current Ia is applied.

The period t1 in which the inversion pulse current is applied should be, for example, longer than or equal to one hundredth of the period t2 in which the current Ia is applied and shorter than or equal to one third of the period t2. Specifically, given that t1 is shorter than t2, the period t1 is preferably longer than or equal to 0.1 seconds and shorter than or equal to 3 minutes, typically longer than or equal to 3 seconds and shorter than or equal to 30 seconds.

FIG. 1A shows an example where the amount (absolute value) of inversion pulse current Iinv is greater than the amount (absolute value) of current Ia. The amount of inversion pulse current Iinv may be less than or equal to that of current Ia. In this embodiment, it is sufficient that the inversion pulse current Iinv flows between the positive electrode and the negative electrode during an interval or intervals between periods in which the current Ia is applied.

Note that the number of times the inversion pulse current is applied in one charging period (until the secondary battery is fully charged) is selected appropriately as long as lithium deposition is inhibited. In addition, timing and the amount of current at the time of application of the inversion pulse current are selected appropriately as long as lithium deposition is inhibited.

During one charging period (until the secondary battery is fully charged), the inversion pulse current can be applied more than once with the period t1 in which the inversion pulse current is applied varied. By applying the inversion pulse current more than once, lithium deposition is inhibited and dissolution of deposited lithium is promoted; thus, deterioration of the secondary battery can be suppressed.

The interval between the timings of the application of the inversion pulse current and the interval between the timings of the application of the charging current can be inconstant, and the period t2 in which the charging current is applied during one charging period (until the secondary battery is fully charged) can vary. For example, the period in which the inversion pulse current is applied can be shorter as the secondary battery is close to full charge.

Lithium deposition noticeably occurs in rapid charging or charging in a low-temperature environment when the concentration of a lithium salt in an electrolytic solution is lower than 1.0 M. Therefore, lithium deposition can be inhibited and a lithium deposit can be dissolved effectively by applying the inversion pulse current more than once, particularly in the case where rapid charging or charging in a low-temperature environment is performed on a secondary battery in which the concentration of a lithium salt in an electrolytic solution is lower than 1.0 M.

In this specification, “rapid charging” refers to a charge rate greater than or equal to 1 C and less than 20 C. Note that in this specification, when LiFePO₄ is used for the positive electrode of the secondary battery and the theoretical capacity of the LiFePO₄ is 170 mAh/g, a charging current of 170 mA is 1 C (170 mA/g) assuming that the weight of the LiFePO₄ as the positive electrode is 1 g. In this case, an ideal battery is fully charged in an hour. Further, provided that 1 g of LiFePO₄ is a positive electrode, charging at a charge rate of 2 C means that charging is performed by applying a charging current of 340 mA for 0.5 hours.

### <Effects of Preventing or Suppressing Deterioration Produced by Application of Inversion Pulse Current>

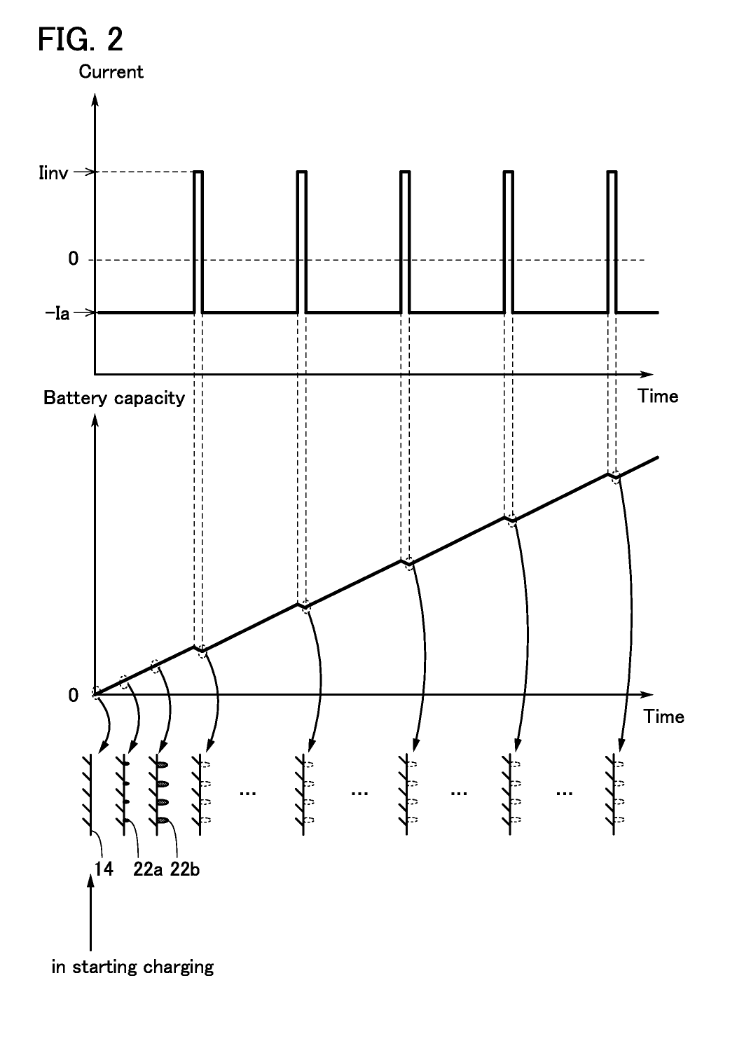

Effects of preventing or suppressing deterioration of a battery produced by application of an inversion pulse current is described with reference to FIG. 2.

FIG. 2 illustrates a graph showing a change over time in current (i.e., the charging current Ia and the inversion pulse current Iinv) which is described with reference to FIGS. 1A and 1B and applied from the positive electrode 12 in charging, a graph showing a change over time in battery capacity which changes due to the current, and a schematic diagram illustrating a process of deposition and dissolution of a reaction product on a surface of the negative electrode 14.

A charging method is a constant current charging. First, when charging is started, a reaction product is not deposited on the surface of the negative electrode 14, that is, the secondary battery 10 is in the initial state just after shipment. When the charging current Ia is kept being supplied to the secondary battery 10, a reaction product 22a is deposited on the surface of the negative electrode 14. The reaction product 22a is a deposit of a metal such as lithium, for example. As time passes, the reaction product 22a is grown to be a reaction product 22b. Then, by applying the inversion pulse current Iinv, the surface of the negative electrode 14 can be restored to the state where the reaction product 22b does not exist on the surface of the negative electrode 14. The reaction product 22b is changed into ions and dissolves into the electrolytic solution 13 due to electrical charges supplied in application of the inversion pulse current Iinv, for example.

Then, the application of the inversion pulse current Iinv is stopped and the charging current Ia is applied. When the charging current Ia is applied, the reaction product 22b is deposited on the surface of the negative electrode 14 again; however, the reaction product 22b can be dissolved every time the inversion pulse current Iinv is applied.

Thus, it is possible that the reaction product 22b does not exist on the surface of the negative electrode 14 at the time of termination of charging, as in starting charging (at the time of shipment). That is, it is preferable that the surface of the negative electrode 14 be restored to the state where the reaction product 22b does not exist on the surface of the negative electrode 14 by applying the inversion pulse current Iinv once. Such charging can be performed when the amount of inversion pulse current Iinv, the period t1 in which the inversion pulse current Iinv is applied, and an interval between the periods in which the inversion pulse current is applied (corresponding to the period t2 in which the charging current Ia is applied) are adjusted.

For example, as the period t2 in which the charging current Ia is applied increases, the amount of the reaction product increases and thus it becomes more difficult to dissolve, and the reaction product alters or is solidified (increased in density) more significantly and thus it becomes more difficult to dissolve. Therefore, in order that the surfaces of the negative electrode and the positive electrode be maintained favorable, the amount of inversion pulse current Iinv, the period t1, and the period t2 are set as described above.

### <Application of Charging Current and Inversion Pulse Current to Secondary Battery>

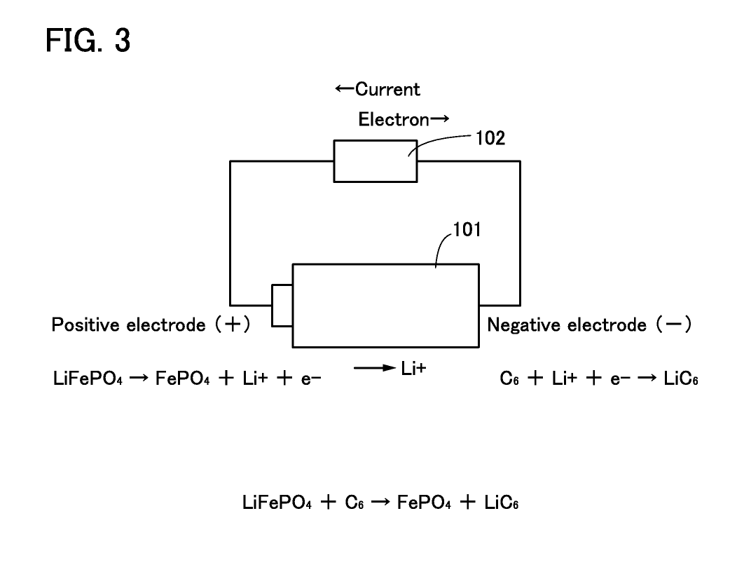

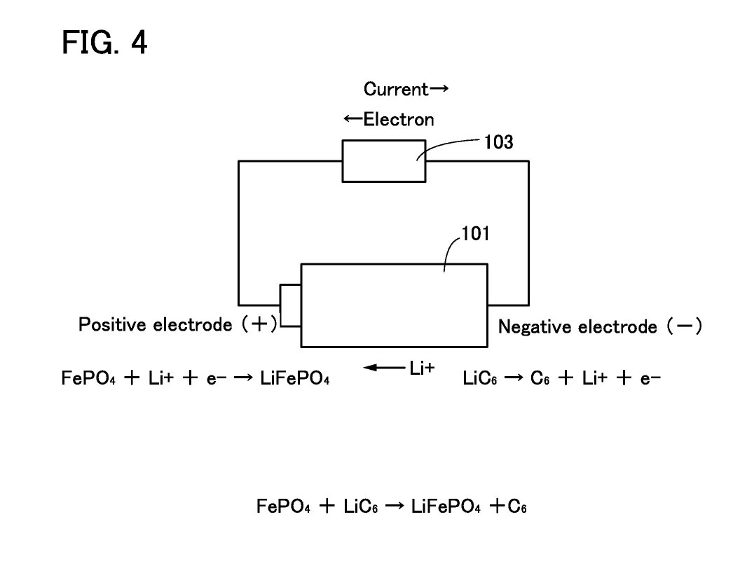

Next, description is given of a principle of operation of a lithium-ion secondary battery that is the secondary battery and a principle of lithium deposition with reference to FIG. 3 and FIG. 4.

FIG. 3 is a schematic diagram illustrating an electrochemical reaction of a lithium-ion secondary battery in a period during which the charging current is applied (charging). FIG. 4 is a schematic diagram illustrating an electrochemical reaction of the lithium-ion secondary battery in a period during which the inversion pulse current is applied (discharging). In FIG. 3, a reference numeral 101 denotes the lithium-ion secondary battery, and a reference numeral 102 denotes a charger. In FIG. 4, a reference numeral 103 denotes a load.

The lithium-ion secondary battery 101 illustrated in FIG. 3 and FIG. 4 is a secondary battery including a positive electrode that includes lithium iron phosphate (LiFePO₄) as a positive electrode active material and a negative electrode that includes graphite as a negative electrode active material.

As illustrated in FIG. 3, a reaction of Formula (1) occurs in the positive electrode when the lithium-ion secondary battery 101 is charged.

LiFePO₄→FePO₄+Li⁺+e⁻ (1)

A reaction of Formula (2) occurs at a negative electrode.

C₆+Li⁺+e⁻>LiC₆ (2)

Thus, the overall reaction in charging the lithium-ion secondary battery is expressed by Formula (3).

LiFePO₄+C₆→FePO₄+LiC₆ (3)

When the lithium-ion secondary battery 101 is charged, in general, lithium is stored in graphite in the negative electrode; however, in the case where deposition of a lithium metal occurs at the negative electrode during charging for any reason, a reaction expressed by Formula (4) occurs. That is, both a reaction of lithium intercalation into graphite and a lithium deposition reaction occur at the negative electrode.

Li⁺+e⁻→Li (4)

The equilibrium potentials of the positive electrode and the negative electrode are determined by a material and an equilibrium state of the material. The potential difference (voltage) between the electrodes varies depending on the equilibrium states of the materials of the positive electrode and the negative electrode.

In this embodiment, the concentration of a lithium salt in an electrolytic solution is lower than 1.0 M. As described above, in such a condition, lithium deposition easily occurs in a negative electrode.

Here, the relationship between an electrode potential E of the lithium-ion secondary battery 101 and the concentration of lithium ions represented by Formula (2) can be represented by Formula (5), the Nernst equation.

$$E = {E}^{0} + \frac{RT}{n F} ln \frac{[ {C}_{6} ] [ {Li}^{+} ]}{[ {LiC}_{6} ]} \qquad ( 5 )$$

In Formula (5), E⁰ is a standard electrode potential, R is a gas constant, T is a temperature, n is the number of electrons that migrate, and F is the Faraday constant.

Formula (5) shows that as the concentration of lithium ions decreases, the electrode potential decreases. That is, the lower the concentration of a lithium salt in an electrolytic solution is, the lower the negative electrode potential, i.e., the electrode potential of the negative electrode, is. As the negative electrode potential becomes lower, it becomes closer to the deposition potential of lithium, resulting in an increase in the amount of lithium deposited in the negative electrode.

One embodiment of the present invention is a secondary battery in which the concentration of a lithium salt in an electrolytic solution is lower than 1.0 M, and in charging the secondary battery, a charging current that flows from a negative electrode to a positive electrode and an inversion pulse current that flows in the direction opposite to that of the charging current are alternately applied repeatedly to the positive electrode and the negative electrode.

The structure makes it possible to promote inhibition of lithium deposition in the negative electrode and dissolution of lithium deposited in the negative electrode. By applying the inversion pulse current more than once, deterioration of a lithium-ion secondary battery due to repeated charging can be suppressed even when it is a secondary battery in which the concentration of a lithium salt in an electrolytic solution is lower than 1.0 M and therefore lithium is easily deposited.

Note that the concentration of the lithium salt in the electrolytic solution is preferably lower than 1.0 M here, and a lithium salt concentration of 1.0 M or higher is not preferable because it increases the viscosity of the electrolytic solution and reduces charging capacity and discharging capacity in charging at high rate or low temperature.

The concentration of the lithium salt in the electrolytic solution is preferably lower than 1.0 M here; however, when the concentration of the lithium salt is too low, supply of lithium ions to the negative electrode is not enough and charging capacity and discharging capacity are reduced in charging at high rate or low temperature, which is not preferable. Further, too low a concentration of the lithium salt in the electrolytic solution reduces the conductivity of the electrolytic solution, in which case the battery might not function properly. Furthermore, too low a concentration of the lithium salt in the electrolytic solution increases the amount of lithium deposition; therefore, a lithium deposit cannot be dissolved sufficiently depending on the condition even when part of the lithium deposit can be dissolved by applying the inversion pulse current more than once. For these reasons, the concentration of the lithium salt in the electrolytic solution is preferably higher than 0.25 M and lower than 1.0 M.

In one embodiment of the present invention, the concentration of the lithium salt in the electrolytic solution can be lowered to a level at which lithium is deposited in the negative electrode; therefore, the amount of solute dissolved in the electrolytic solution can be reduced and the viscosity of the electrolytic solution can be decreased.

As illustrated in FIG. 4, a reaction of Formula (6) occurs in the positive electrode when the lithium-ion secondary battery 101 is discharged.

FePO₄+Li⁺+e⁻→LiFePO₄ (6)

In addition, a reaction expressed by Formula (7) occurs in the negative electrode.

LiC₆→C₆+Li⁺+e⁻ (7)

Thus, the overall reaction in discharging the lithium-ion secondary battery is expressed by Formula (8).

FePO₄+LiC₆→LiFePO₄+C₆ (8)

In addition, in discharging performed after the lithium metal is deposited, a reaction expressed by Formula (9) occurs in the negative electrode. That is, both a reaction of lithium deintercalation from graphite and a lithium dissolution reaction occur at the negative electrode.

Li→Li⁺+e⁻ (9)

### <Positive Electrode Potential and Negative Electrode Potential>

A positive electrode potential is an electrochemical equilibrium potential of a positive electrode active material, and a negative electrode potential is an electrochemical equilibrium potential of a negative electrode active material. For example, a potential at which a lithium metal is in electrochemical equilibrium in an electrolytic solution is 0 V (vs. Li/Li⁺). The same applies to other substances.

When the electrode potential is lower than 0 V (vs. Li/Li⁺), lithium ions in the electrolytic solution are easily deposited as lithium. In contrast, when the electrode potential is higher than 0 V (vs. Li/Li⁺), deposited lithium is easily dissolved into the electrolytic solution as lithium ions.

The electrochemical equilibrium potential of a lithium compound used for the positive electrode active material can be determined based on the potential of lithium. For example, the electrochemical equilibrium potential of lithium iron phosphate (LiFePO₄) is approximately 3.5 V (vs. Li/Li⁺). The electrochemical equilibrium potential of graphite is approximately 0.2 V (vs. Li/Li⁺).

Thus, the voltage of a lithium-ion secondary battery including lithium iron phosphate (LiFePO₄) as a positive electrode active material and graphite as a negative electrode active material (the electromotive force of an electrochemical cell) is 3.3 V, which is the difference in potential between the positive and negative electrode active materials. The negative electrode potential which is as low as the potential of a lithium metal is a factor of the high cell voltage, which is a feature of the lithium-ion secondary battery.

Deposition of lithium on a surface of the negative electrode is a cause of a decrease in the reliability and a reduction in battery capacity of the lithium-ion secondary battery. The negative electrode potential (the electrochemical equilibrium potential of graphite) is approximately 0.2 V (vs. Li/Li⁺), which is close to the deposition potential of lithium, 0 V (vs. Li/Li^{±}); accordingly, lithium is easily deposited on the surface of the negative electrode. The factor of the high cell voltage, which is a feature of a lithium-ion secondary battery, is a cause of lithium deposition.

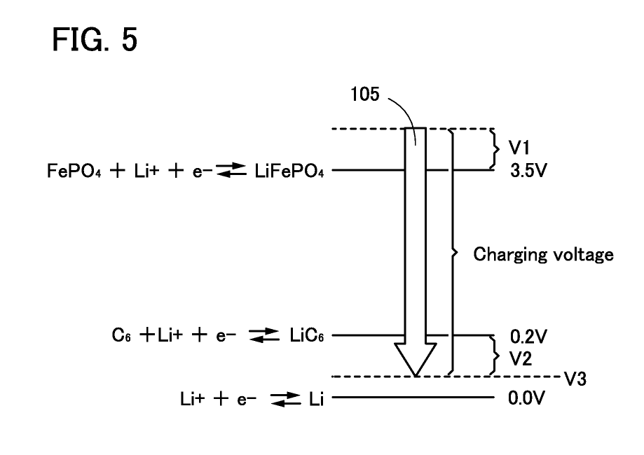

This is described with reference to FIG. 5. FIG. 5 schematically illustrates the relationship between the potential of a positive electrode and the potential of a negative electrode of a secondary battery. As an example, the secondary battery includes lithium iron phosphate as the positive electrode and graphite as the negative electrode. Note that an arrow 105 denotes a charging voltage in FIG. 5.

The potential difference between the positive electrode including lithium iron phosphate and the negative electrode including graphite in electrochemical equilibrium is as follows: 3.5 V−0.2 V=3.3 V. At a charging voltage of 3.3 V, the reaction of Formula (1) and the reaction of Formula (6) equilibrate in the positive electrode and the reaction of Formula (2) and the reaction of Formula (7) equilibrate in the negative electrode; thus, a current does not flow.

For this reason, a charging voltage higher than 3.3 V needs to be applied between the positive electrode and the negative electrode so that a charging current flows. The voltage for applying the charging current is referred to as an overvoltage. For example, on the assumption that a series resistance component inside the secondary battery is ignored and all extra charging voltage is used in the electrode reactions of Formulae (1) and (2), as indicated by the arrow 105, the extra charging voltage is shared by the positive electrode and the negative electrode as an overvoltage (V1) to the positive electrode and an overvoltage (V2) to the negative electrode.

In order to obtain a higher current density per unit electrode area, a higher overvoltage is needed. For example, when the battery is rapidly charged, a current density per unit surface area of an active material needs to be high, in which case a higher overvoltage is needed.

However, as the overvoltage is raised to increase the current density per unit surface area of the active material, the overvoltage V2 to the negative electrode increases; therefore, a potential V3 shown by the tip of the arrow 105 in FIG. 5 becomes lower than the deposition potential of the lithium. Then, the reaction of Formula (4) occurs. That is to say, lithium is deposited on the surface of the negative electrode.

Further, with the structure in this embodiment, the secondary battery is charged in the condition in which the concentration of the lithium salt in the electrolytic solution is lower than 1.0 M, that is, the concentration of lithium ions is low. For this reason, as described with Formula (5), the negative electrode potential becomes close to the deposition potential of lithium, so that lithium deposition easily occurs.

Therefore, the technical idea of alternately applying the charging current and the inversion pulse current is used to promote inhibition of lithium deposition and dissolution of deposited lithium in charging, which suppresses deterioration of the secondary battery.

In rapid charging, the potential of the negative electrode lowers and thus, lithium becomes more likely to be deposited. In a low-temperature environment, the resistance of the negative electrode increases, so that the potential of the negative electrode further lowers and lithium becomes more likely to be deposited accordingly. However, the above technical idea enables rapid charging of a lithium-ion secondary battery and charging of a lithium-ion secondary battery in a low-temperature environment.

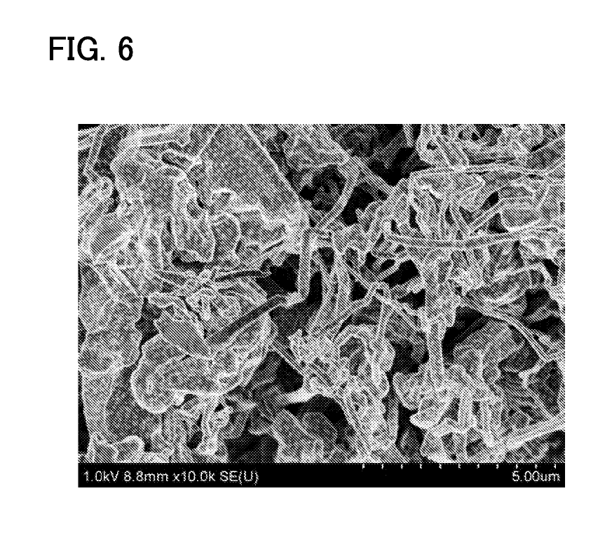

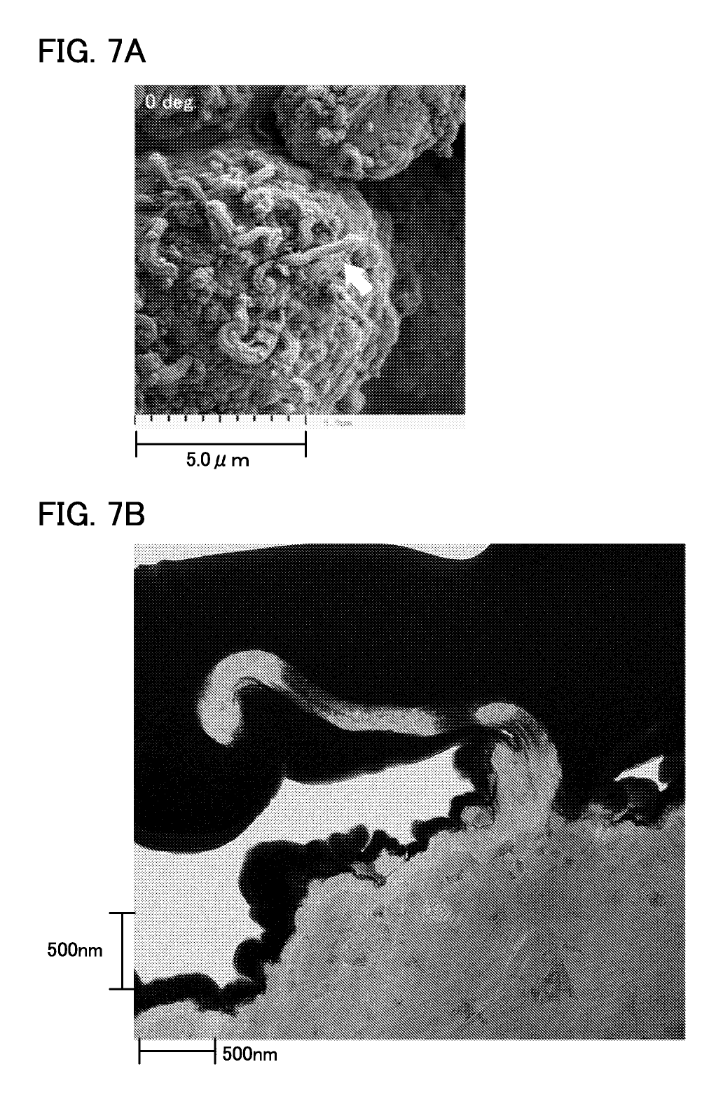

A charged coin-type lithium-ion secondary battery (a positive electrode is formed using LiFePO₄, a negative electrode is formed using graphite, and a separator is formed using polypropylene) was disassembled. FIG. 6 is a scanning electron microscope (SEM) image of lithium whiskers deposited on a surface of the graphite. FIGS. 7A and 7B show observation results of some of lithium whiskers formed on a surface of a negative electrode active material in another lithium-ion secondary battery that operated abnormally in charging. FIG. 7A is a plane image obtained by a scanning ion microscope (SIM). Note that surfaces of the lithium whiskers are covered with platinum that is a protective film in FIG. 6 and FIGS. 7A and 7B. There is a lithium whisker in a portion indicated by the white arrow in FIG. 7A. FIG. 7B is a cross-sectional image observed in the direction of the arrow in the SIM image. In the observation, a transmission electron microscope (TEM), H-9000NAR, manufactured by Hitachi High-Technologies Corporation was used at an acceleration voltage of 200 kV and a magnification of 55,000 times.

As shown in FIG. 6 and FIGS. 7A and 7B, the lithium whiskers are deposited. The “whisker” is a crystal that has grown outward from a crystal surface in a whisker shape.

During the period in which the charging current is applied, the lithium whiskers are not uniformly deposited on the entire surface of the electrode as time passes. Once a lithium whisker is deposited, lithium is more likely to be deposited on the position where the lithium whisker has been deposited than on the other positions, and a larger amount of lithium is deposited on the position and grown to be a large lump. The region where a large amount of lithium has been deposited has higher conductivity than the other region. For this reason, a current is likely to concentrate at the region where the large amount of lithium has been deposited, and the lithium is grown around the region faster than in the other region. Accordingly, projections and depressions are formed by the region where a large amount of lithium is deposited and the region where a small amount of lithium is deposited, and the projections and the depressions become larger as time goes by. Finally, the large projections and depressions cause severe deterioration of the battery.

Lithium is dissolved by applying a current that flows in the direction opposite to the direction of a current with which lithium whiskers are formed, that is, the inversion pulse current here. When the inversion pulse current is applied in the state where the projections and depressions are formed due to non-uniform deposition of lithium whiskers, a current concentrates at the projections and lithium is dissolved. Lithium dissolution means that lithium in a region in the electrode surface where a large amount of lithium is deposited is dissolved to reduce the area of the region where a large amount of lithium is deposited, preferably means that the electrode surface is restored to the state at the time before lithium is deposited on the electrode surface. As well as restoration of the electrode surface to the state at the time before lithium is deposited on the electrode surface, even reduction of lithium can provide a significant effect.

In charging the lithium-ion secondary battery, the inversion pulse current is applied to at least one of the positive electrode and the negative electrode more than once so that a current flows in a direction opposite to that of the charging current with which lithium whiskers are deposited. Application of the inversion pulse current in such a manner makes it possible to suppress deterioration of the lithium-ion secondary battery.

### <Example of Structure of Battery>

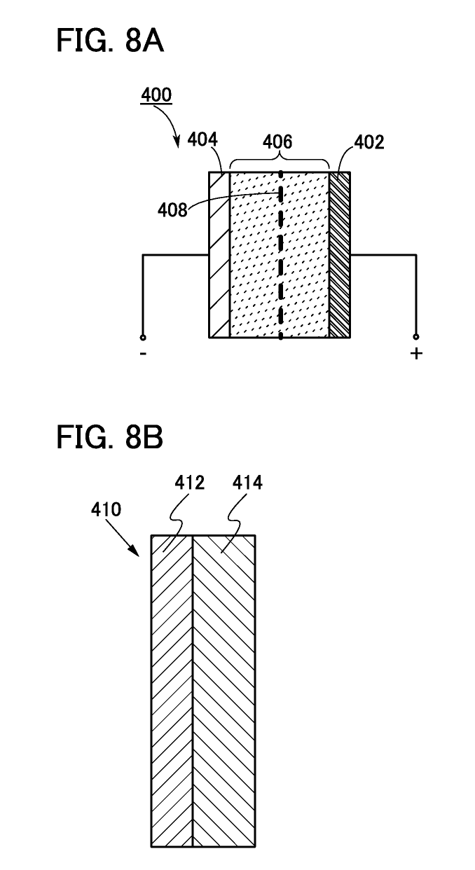

An example of a structure of the secondary battery is described with reference to FIGS. 8A and 8B.

FIG. 8A is a cross-sectional view of a secondary battery 400. A positive electrode 402 includes at least a positive electrode current collector and a positive electrode active material layer in contact with the positive electrode current collector. A negative electrode 404 includes at least a negative electrode current collector and a negative electrode active material layer in contact with the negative electrode current collector. The positive electrode active material layer faces the negative electrode active material layer, and an electrolytic solution 406 and a separator 408 are provided between the positive electrode active material layer and the negative electrode active material layer.

As the secondary battery 400, a lithium-ion secondary battery can be used, for example.

Note that this embodiment can be applied not only to secondary batteries but also to devices that utilize an electrochemical reaction (electrochemical devices); for example, this embodiment can be applied to metal-ion capacitors such as a lithium-ion capacitor.

FIG. 8B is a cross-sectional view of an electrode 410 (corresponding to the positive electrode 402 and the negative electrode 404 in FIG. 8A) for a secondary battery. As illustrated in FIG. 8B, in the electrode 410, an active material layer 414 is provided over the current collector 412. The active material layer 414 is formed over only one surface of the current collector 412 in FIG. 8B; however, active material layers 414 may be formed so that the current collector 412 is sandwiched therebetween. The active material layer 414 does not necessarily need to be formed over the entire surface of the current collector 412 and a region that is not coated, such as a region for connection to an external terminal, is provided as appropriate.

### <Current Collector>

The current collector 412 can be formed using a highly conductive material which is not alloyed with a carrier ion of lithium or the like, such as a metal typified by stainless steel, gold, platinum, zinc, iron, nickel, copper, aluminum, titanium, or tantalum or an alloy thereof. Alternatively, an aluminum alloy to which an element which improves heat resistance, such as silicon, titanium, neodymium, scandium, or molybdenum, is added can be used. Still alternatively, a metal element which forms silicide by reacting with silicon can be used. Examples of the metal element which forms silicide by reacting with silicon include zirconium, titanium, hafnium, vanadium, niobium, tantalum, chromium, molybdenum, tungsten, cobalt, and nickel. The current collector 412 can have a foil-like shape, a plate-like shape (sheet-like shape), a net-like shape, a cylindrical shape, a coil shape, a punching-metal shape, an expanded-metal shape, or the like, as appropriate. The current collector 412 preferably has a thickness of greater than or equal to 10 μm and less than or equal to 30 μm.

### <Active Material Layer>

The active material layer 414 includes at least an active material. The active material layer 414 may further include a binder for increasing adhesion of particles of the active material, a conductive additive for increasing the conductivity of the active material layer 414, and the like in addition to the active material.

### <Positive Electrode Active Material>

In the case of using the electrode 410 for a secondary battery as the positive electrode 402 of the secondary battery, a material into and from which lithium ions can be inserted and extracted can be used for the active material (hereinafter referred to as a positive electrode active material) included in the active material layer 414. Examples of such a positive electrode active material are a lithium-containing complex phosphate with an olivine crystal structure, a lithium-containing complex phosphate with a layered rock-salt crystal structure, and a lithium-containing complex phosphate with a spinel crystal structure. Specifically, a compound such as LiFeO₂, LiCoO₂, LiNiO₂, LiMn₂O₄, V₂O₅, Cr₂O₅, or MnO₂ can be used for the positive electrode active material.

Typical examples of the lithium-containing complex phosphate (LiMPO₄ (general formula) (M is one or more of Fe(II), Mn(II), Co(II), and Ni(II))) are LiFePO₄, LiNiPO₄, LiCoPO₄, LiMnPO₄, LiFeₐNi_{b}PO₄, LiFeₐCo_{b}PO₄, LiFeₐMn_{b}PO₄, LiNiₐCo_{b}PO₄, LiNiₐMn_{b}PO₄ (a+b 1, 0<a<1, and 0<b<1), LiFe_{c}Ni_{d}CoₑPO₄, LiFe_{c}Ni_{d}MnₑPO₄, LiNi_{c}Co_{d}MnₑPO₄ (c+d+e 1, 0<c<1, 0<d<1, and 0<e<1), and LiFe_{f}Ni_{g}CoₕMnᵢPO₄ (f+g+h+i≦1, 0<f<1, 0<g<1, 0<h<1, and 0<i<1).

LiFePO₄ is particularly preferable because it properly satisfies conditions necessary for the positive electrode active material, such as safety, stability, high capacity density, high potential, and the existence of lithium ions which can be extracted in initial oxidation (charging). Note that the theoretical capacity of LiFePO₄ is 170 mAh/g.

### <Negative Electrode Active Material>

When the electrode 410 for a secondary battery is used as the negative electrode 404 of the secondary battery, a material with which lithium can be dissolved and deposited or a material into and from which lithium ions can be inserted and extracted can be used for an active material (hereinafter referred to as a negative electrode active material) included in the active material layer 414; for example, a lithium metal, a carbon-based material, an alloy-based material, or the like can be used.

The lithium metal is preferable because of its low redox potential (3.045 V lower than that of a standard hydrogen electrode) and high specific capacity per unit weight and per unit volume (3860 mAh/g and 2062 mAh/cm³).

Examples of the carbon-based material include graphite, graphitizing carbon (soft carbon), non-graphitizing carbon (hard carbon), a carbon nanotube, graphene, and carbon black.

Examples of the graphite include artificial graphite such as meso-carbon microbeads (MCMB), coke-based artificial graphite, or pitch-based artificial graphite and natural graphite such as spherical natural graphite.

Graphite has a low potential substantially equal to that of a lithium metal (0.1 V to 0.3 V vs. Li/Li⁺) while lithium ions are intercalated into the graphite (when a lithium-graphite intercalation compound is formed). For this reason, a lithium-ion secondary battery can have a high operating voltage. In addition, graphite is preferable because of its advantages such as relatively high capacity per unit volume, small volume expansion, low cost, and safety greater than that of a lithium metal.

### <Binder>

As the binder, polyvinylidene fluoride (PVDF) as a typical example, polyimide, polytetrafluoroethylene, polyvinyl chloride, ethylene-propylene-diene polymer, styrene-butadiene rubber, acrylonitrile-butadiene rubber, fluorine rubber, polyvinyl acetate, polymethyl methacrylate, polyethylene, nitrocellulose, or the like can be used.

### <Conductive Additive>

As a conductive additive, a material that has a large specific surface area is preferably used; for example, acetylene black (AB) can be used. Alternatively, a carbon material such as a carbon nanotube, graphene, or fullerene can be used.

Graphene is flaky and has an excellent electrical characteristic of high conductivity and excellent physical properties of high flexibility and high mechanical strength. Thus, the use of graphene as the conductive additive can increase contact points and the contact area of particles of an active material.

Note that graphene in this specification includes single-layer graphene and multilayer graphene including two or more and a hundred or less layers. Single-layer graphene refers to a one-atom-thick sheet of carbon molecules having π bonds. Graphene oxide refers to a compound formed by oxidation of such graphene. When graphene oxide is reduced to form graphene, oxygen contained in the graphene oxide is not entirely extracted and part of the oxygen remains in the graphene. When the graphene contains oxygen, the proportion of oxygen, which is measured by X-ray photoelectron spectroscopy (XPS), is higher than or equal to 2 atomic % and lower than or equal to 20 atomic %, preferably higher than or equal to 3 atomic % and lower than or equal to 15 atomic %.

In the case where graphene is multilayer graphene including graphene obtained by reducing graphene oxide, the interlayer distance between graphenes is greater than 0.34 nm and less than or equal to 0.5 nm, preferably greater than or equal to 0.38 nm and less than or equal to 0.42 nm, more preferably greater than or equal to 0.39 nm and less than or equal to 0.41 nm. In general graphite, the interlayer distance between single-layer graphenes is 0.34 nm. Since the interlayer distance between the graphenes obtained by reducing graphene oxides is longer than that in general graphite, carrier ions can easily transfer between the graphenes in multilayer graphene.

As the conductive additive, metal powder or metal fibers of copper, nickel, aluminum, silver, gold, or the like, a conductive ceramic material, or the like can alternatively be used instead of the above carbon material.

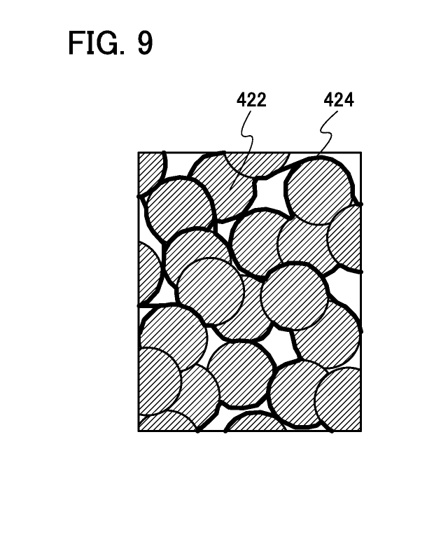

Here, an active material layer including graphene as a conductive additive is described with reference to FIG. 9.

FIG. 9 is an enlarged longitudinal cross-sectional view of the active material layer 414. The active material layer 414 includes active material particles 422, graphene 424 as a conductive additive, and a binder (not illustrated).

The longitudinal cross section of the active material layer 414 shows substantially uniform dispersion of the sheet-like graphene 424 in the active material layer 414. The graphene 424 is schematically shown by thick lines in FIG. 9 but is actually a thin film having a thickness corresponding to the thickness of a single layer or a multi-layer of carbon molecules. The plurality of graphenes 424 are formed in such a way as to wrap, coat, or be adhered to a plurality of the active material particles 422, so that the graphenes 424 make surface contact with the plurality of the active material particles 422. Further, the graphenes 424 are also in surface contact with each other; consequently, the plurality of graphenes 424 form a three-dimensional network for electronic conduction.

This is because graphene oxides with an extremely high dispersion property in a polar solvent are used as a raw material of the graphenes 424. The solvent is removed by volatilization from a dispersion medium containing the graphene oxides uniformly dispersed and the graphene oxides are reduced to give graphenes; hence, the graphenes 424 remaining in the active material layer 414 partly overlap with each other and are dispersed such that surface contact is made, thereby forming a path for electronic conduction.

Unlike a conductive additive in the form of particles, such as acetylene black, which makes point contact with the active material, the graphene 424 is capable of surface contact with low contact resistance; accordingly, the electronic conduction of the active material particles 422 and the graphene 424 can be improved without an increase in the amount of conductive additive. Thus, the proportion of the active material particles 422 in the active material layer 414 can be increased. Accordingly, the discharge capacity of a storage battery can be increased.

### <Electrolytic Solution>

As an electrolyte dissolved in the electrolytic solution 406, a material including carrier ions is used. Typical examples of the electrolyte are lithium salts such as LiPF₆, LiClO₄, LiAsF₆, LiBF₄, LiCF₃SO₃, Li(CF₃SO₂)₂N, and Li(C₂F₅SO₂)₂N. One of these electrolytes may be used alone or two or more of them may be used in an appropriate combination and in an appropriate ratio. For further stabilization, a small amount (1 wt %) of vinylene carbonate (VC) may be added to the electrolytic solution so that the decomposition amount of the electrolytic solution is further reduced.

Note that when carrier ions are alkali metal ions other than lithium ions, or alkaline-earth metal ions, instead of lithium in the above lithium salts, an alkali metal (e.g., sodium or potassium) or an alkaline-earth metal (e.g., calcium, strontium, barium, beryllium, or magnesium) may be used for the electrolyte.

As a solvent of the electrolytic solution, a material in which carrier ions can transfer is used. As the solvent of the electrolytic solution, an aprotic organic solvent is preferably used. Typical examples of the aprotic organic solvent include ethylene carbonate (EC), propylene carbonate, dimethyl carbonate, diethyl carbonate (DEC), γ-butyrolactone, acetonitrile, dimethoxyethane, and tetrahydrofuran, and one or more of these materials can be used. With the use of a gelled high-molecular material as the solvent of the electrolytic solution, safety against liquid leakage and the like is improved. Further, the storage battery can be thinner and more lightweight. Typical examples of the gelled high-molecular material include a silicone gel, an acrylic gel, an acrylonitrile gel, polyethylene oxide, polypropylene oxide, a fluorine-based polymer, and the like. Alternatively, the use of one or more of ionic liquids (room temperature molten salts) which have features of non-flammability and non-volatility as a solvent of the electrolytic solution can prevent the storage battery from exploding or catching fire even when the storage battery internally shorts out or the internal temperature increases owing to overcharging or the like.

### <Separator>

As the separator 15, cellulose (paper) or a porous film formed of a polyolefin resin (e.g., polypropylene or polyethylene) with micropores can be used.

Although the case where lithium is deposited is described as an example in this embodiment, the present invention is not limited thereto. One embodiment of the present invention can be applied to any battery as long as the battery deteriorates due to products deposited in an electrode and deterioration of the battery can be suppressed by applying the inversion pulse current more than once in a charging period.

### Embodiment 2

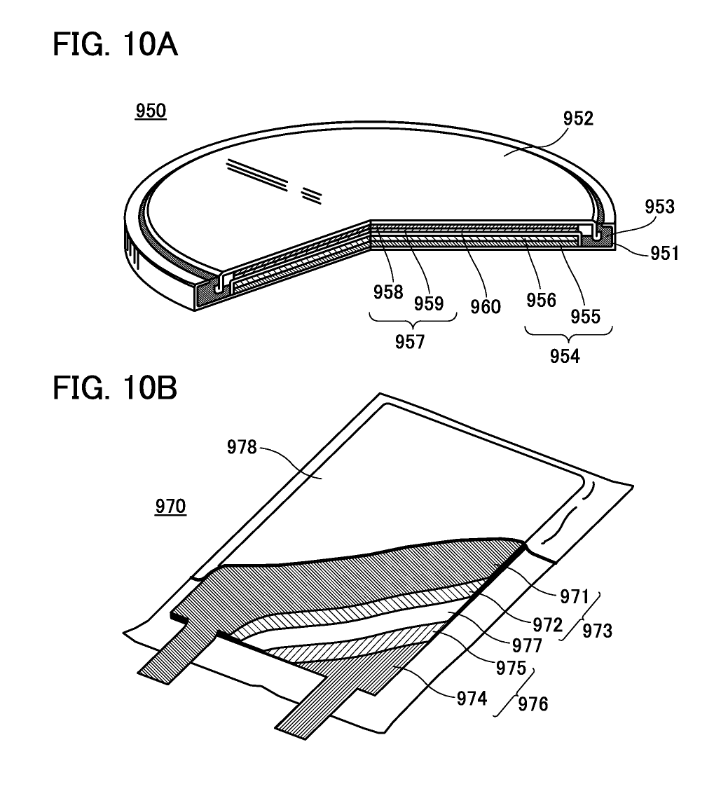

In this embodiment, structures of nonaqueous secondary batteries are described with reference to FIGS. 10A and 10B, FIGS. 11A and 11B, and FIGS. 12A to 12C.

FIG. 10A is an external view of a coin-type (single-layer flat type) lithium-ion secondary battery, part of which illustrates a cross-sectional view of part of the coin-type lithium-ion secondary battery.

In a coin-type secondary battery 950, a positive electrode can 951 serving also as a positive electrode terminal and a negative electrode can 952 serving also as a negative electrode terminal are insulated and sealed with a gasket 953 formed using polypropylene or the like. A positive electrode 954 includes a positive electrode current collector 955 and a positive electrode active material layer 956 provided in contact with the positive electrode current collector 955. A negative electrode 957 includes a negative electrode current collector 958 and a negative electrode active material layer 959 provided in contact with the negative electrode current collector 958. A separator 960 and an electrolytic solution (not illustrated) are provided between the positive electrode active material layer 956 and the negative electrode active material layer 959.

The negative electrode 957 includes the negative electrode current collector 958 and the negative electrode active material layer 959. The positive electrode 954 includes the positive electrode current collector 955 and the positive electrode active material layer 956.

For the positive electrode 954, the negative electrode 957, the separator 960, and the electrolytic solution, the above-described materials can be used.

For the positive electrode can 951 and the negative electrode can 952, a metal having corrosion resistance to an electrolytic solution, such as nickel, aluminum, or titanium, an alloy of such a metal, or an alloy of such a metal and another metal (e.g., stainless steel) can be used. Alternatively, the positive electrode can 951 and the negative electrode can 952 are preferably covered with nickel, aluminum, or the like in order to prevent corrosion caused by the electrolytic solution. The positive electrode can 951 and the negative electrode can 952 are electrically connected to the positive electrode 954 and the negative electrode 957, respectively.

The negative electrode 957, the positive electrode 954, and the separator 960 are immersed in the electrolytic solution. Then, as illustrated in FIG. 10A, the positive electrode can 951, the positive electrode 954, the separator 960, the negative electrode 957, and the negative electrode can 952 are stacked in this order with the positive electrode can 951 positioned at the bottom, and the positive electrode can 951 and the negative electrode can 952 are subjected to pressure bonding with the gasket 953 positioned therebetween. In such a manner, the coin-type secondary battery 950 is fabricated.

Next, an example of a laminated secondary battery is described with reference to FIG. 10B. In FIG. 10B, a structure inside the laminated secondary battery is partly exposed for convenience.

A laminated secondary battery 970 illustrated in FIG. 10B includes a positive electrode 973 including a positive electrode current collector 971 and a positive electrode active material layer 972, a negative electrode 976 including a negative electrode current collector 974 and a negative electrode active material layer 975, a separator 977, an electrolytic solution (not illustrated), and an exterior body 978. The separator 977 is provided between the positive electrode 973 and the negative electrode 976 in the exterior body 978. The exterior body 978 is filled with the electrolytic solution. Although the one positive electrode 973, the one negative electrode 976, and the one separator 977 are used in FIG. 10B, the secondary battery may have a stacked structure in which positive electrodes and negative electrodes are alternately stacked and separated by separators.

For the positive electrode, the negative electrode, the separator, and the electrolytic solution (an electrolyte and a solvent), the above-described materials can be used.

In the laminated secondary battery 970 illustrated in FIG. 10B, the positive electrode current collector 971 and the negative electrode current collector 974 also serve as terminals (tabs) for electrical contact with the outside. For this reason, the positive electrode current collector 971 and the negative electrode current collector 974 are arranged so that part of the positive electrode current collector 971 and part of the negative electrode current collector 974 are exposed outside the exterior body 978.

As the exterior body 978 of the laminated secondary battery 970, for example, a laminate film having a three-layer structure where a highly flexible metal thin film of aluminum, stainless steel, copper, nickel, or the like is provided over a film formed of a material such as polyethylene, polypropylene, polycarbonate, ionomer, or polyamide, and an insulating synthetic resin film of a polyamide resin, a polyester resin, or the like is provided as the outer surface of the exterior body over the metal thin film can be used. With such a three-layer structure, permeation of an electrolytic solution and a gas can be blocked and an insulating property and resistance to the electrolytic solution can be obtained.

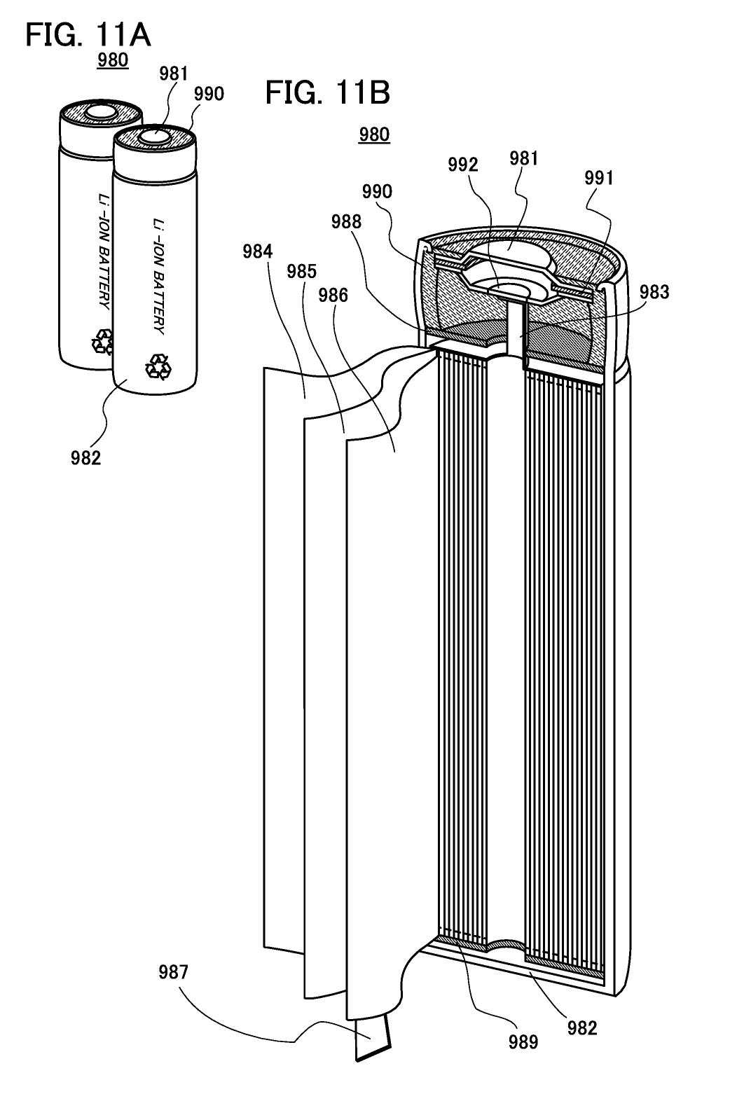

Next, an example of a cylindrical secondary battery is described with reference to FIGS. 11A and 11B. As illustrated in FIG. 11A, a cylindrical secondary battery 980 includes a positive electrode cap (battery cap) 981 on its top surface and a battery can (outer can) 982 on its side surface and bottom surface. The positive electrode cap 981 and the battery can 982 are insulated from each other with a gasket (insulating packing) 990.

FIG. 11B is a schematic view of a cross-section of the cylindrical secondary battery 980. Inside the battery can 982 having a hollow cylindrical shape, a battery element in which a strip-like positive electrode 984 and a strip-like negative electrode 986 are wound with a separator 985 positioned therebetween is provided. Although not illustrated, the battery element is wound around a center pin. One end of the battery can 982 is close and the other end thereof is open.

For the positive electrode 984, the negative electrode 986, and the separator 985, the above-described materials can be used.

For the battery can 982, a metal having corrosion resistance to an electrolytic solution, such as nickel, aluminum, or titanium, an alloy of such a metal, or an alloy of such a metal and another metal (e.g., stainless steel or the like) can be used. Alternatively, the battery can 982 is preferably covered with nickel, aluminum, or the like in order to prevent corrosion caused by the electrolytic solution. Inside the battery can 982, the battery element in which the positive electrode, the negative electrode, and the separator are wound is positioned between a pair of insulating plates 988 and 989 which face each other.

Further, an electrolytic solution (not illustrated) is injected inside the battery can 982 in which the battery element is provided. For the electrolytic solution, the above-described electrolyte and solvent can be used.

Active material layers are formed on both sides of the current collectors because the positive electrode 984 and the negative electrode 986 of the cylindrical secondary battery 980 are wound. A positive electrode terminal (positive electrode current collecting lead) 983 is connected to the positive electrode 984, and a negative electrode terminal (negative electrode current collecting lead) 987 is connected to the negative electrode 986. Both the positive electrode terminal 983 and the negative electrode terminal 987 can be formed using a metal material such as aluminum. The positive electrode terminal 983 and the negative electrode terminal 987 are resistance-welded to a safety valve mechanism 992 and the bottom of the battery can 982, respectively. The safety valve mechanism 992 is electrically connected to the positive electrode cap 981 through a positive temperature coefficient (PTC) element 991. The safety valve mechanism 992 cuts off electrical connection between the positive electrode cap 981 and the positive electrode 984 when the internal pressure of the battery increases and exceeds a predetermined threshold value. The PTC element 991 is a heat sensitive resistor whose resistance increases as temperature rises, and controls the amount of current by increase in resistance to prevent abnormal heat generation. Note that barium titanate (BaTiO₃)-based semiconductor ceramic or the like can be used for the PTC element.

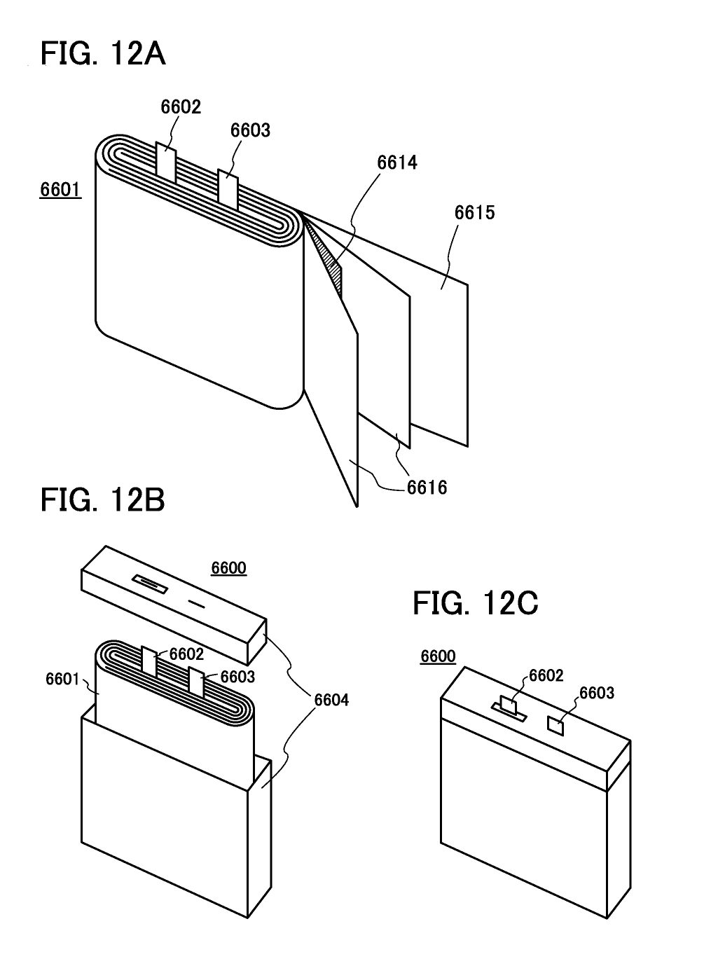

Next, an example of a rectangular secondary battery is described with reference to FIG. 12A. A wound body 6601 illustrated in FIG. 12A includes a terminal 6602 and a terminal 6603. The wound body 6601 is obtained by winding a sheet of a stack in which a negative electrode 6614 and a positive electrode 6615 overlap with each other with a separator 6616 provided therebetween. The wound body 6601 is covered with a rectangular sealing can 6604 or the like as illustrated in FIG. 12B; thus, a rectangular secondary battery 6600 is fabricated. Note that the number of stacks each including the negative electrode 6614, the positive electrode 6615, and the separator 6616 may be determined as appropriate depending on required capacity of the secondary battery 6660 and the volume of the sealing can 6604. FIG. 12C illustrates the sealing can 6604 that is closed.

This embodiment can be freely combined with any of the other embodiments. Specifically, in a charging period of any of the secondary batteries in this embodiment, a current (inversion pulse current) that flows in a direction opposite to that of a current with which a product is formed (typically, lithium whiskers or the like) is applied to promote inhibition of lithium deposition and dissolution of deposited lithium; thus, deterioration of the secondary battery can be suppressed.

### Embodiment 3

An electrochemical device and a method for suppressing deterioration of the electrochemical device, which are embodiments of the present invention, can be used for power sources of various electrical devices. Further, in this embodiment, by applying an inversion pulse current to a secondary battery in a charging period thereof, a maintenance-free secondary battery can be obtained.

Here, “electrical devices” refer to all general industrial products including portions which operate by electric power. Examples of electrical devices each using the electrochemical device and the method for suppressing deterioration of the electrochemical device, which are embodiments of the present invention, are as follows: display devices of televisions, monitors, and the like, lighting devices, desktop personal computers, laptop personal computers, word processors, image reproduction devices which reproduce still images or moving images stored in recording media such as digital versatile discs (DVDs), portable or stationary music reproduction devices such as compact disc (CD) players and digital audio players, portable or stationary radio receivers, recording reproduction devices such as tape recorders and IC recorders (voice recorders), headphone stereos, stereos, remote controls, clocks such as table clocks and wall clocks, cordless phone handsets, transceivers, mobile phones, car phones, portable or stationary game machines, pedometers, calculators, portable information terminals, electronic notebooks, e-book readers, electronic translators, audio input devices such as microphones, cameras such as still cameras and video cameras, toys, electric shavers, electric toothbrushes, high-frequency heating appliances such as microwave ovens, electric rice cookers, electric washing machines, electric vacuum cleaners, water heaters, electric fans, hair dryers, air-conditioning systems such as humidifiers, dehumidifiers, and air conditioners, dishwashers, dish dryers, clothes dryers, futon dryers, electric refrigerators, electric freezers, electric refrigerator-freezers, freezers for preserving DNA, flashlights, electric power tools, smoke detectors, and a health equipment and a medical equipment such as hearing aids, cardiac pacemakers, portable X-ray equipment, radiation counters, electric massagers, and dialyzers. The examples also include industrial equipment such as guide lights, traffic lights, meters such as gas meters and water meters, belt conveyors, elevators, escalators, automatic vending machines, automatic ticket machine, cash dispensers (CD), automated teller machines (ATM), digital signage, industrial robots, radio relay stations, mobile phone base stations, power storage systems, and secondary batteries for leveling the amount of power supply and smart grid.

In the electrical devices, the electrochemical device and the method for suppressing deterioration of the electrochemical device, which are embodiments of the present invention, can be used for a main power source for supplying enough electric power for almost the whole power consumption. Alternatively, in the above electrical devices, the electrochemical device and the method for suppressing deterioration of the electrochemical device, which are embodiments of the present invention, can be used for an uninterruptible power source which can supply electric power to the electrical devices when the supply of electric power from the main power source or a commercial power source is stopped. Further alternatively, in the electrical devices, the electrochemical device of one embodiment of the present invention can be used as an auxiliary power source for supplying electric power to the electrical devices at the same time as the power supply from the main power source or a commercial power source. In addition, the method for suppressing deterioration of the electrochemical device by applying an inversion pulse current can be used in charging the auxiliary power source.

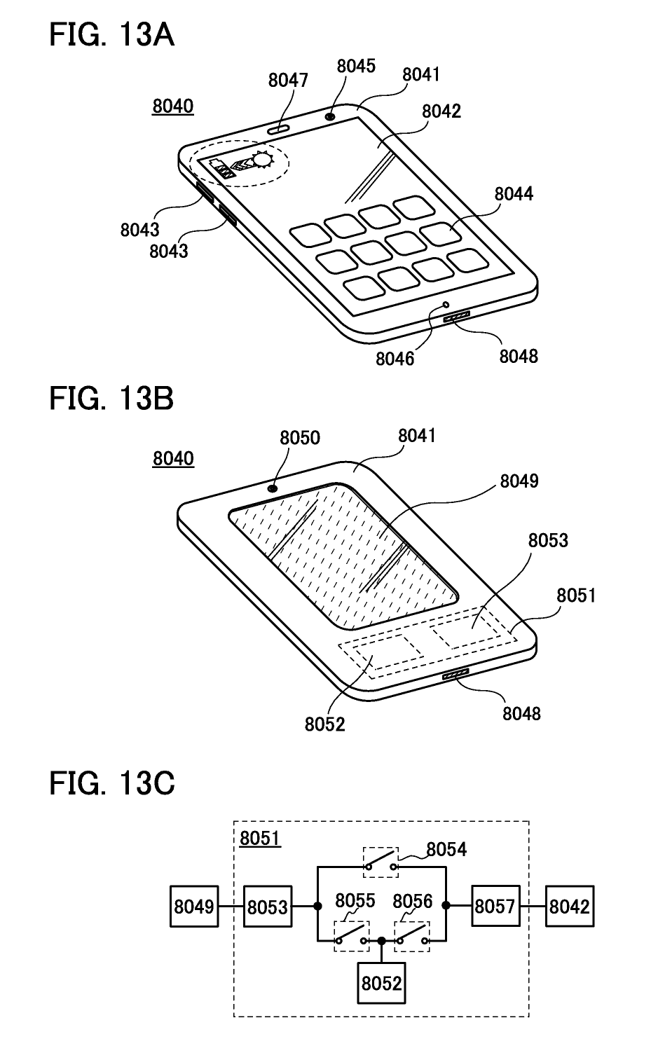

As another example of the electrical devices, a portable information terminal is described with reference to FIGS. 13A to 13C.

FIG. 13A is a perspective view illustrating a front surface and a side surface of a portable information terminal 8040. The portable information terminal 8040 is capable of executing a variety of applications such as mobile phone calls, e-mailing, viewing and editing texts, music reproduction, Internet communication, and a computer game. In the portable information terminal 8040, a housing 8041 includes a display portion 8042, a camera 8045, a microphone 8046, and a speaker 8047 on its front surface, a button 8043 for operation on its left side, and a connection terminal 8048 on its bottom surface.

A display module or a display panel is used for the display portion 8042. Examples of the display module or the display panel are a light-emitting device in which each pixel includes a light-emitting element typified by an organic light-emitting element (OLED); a liquid crystal display device; an electronic paper performing a display in an electrophoretic mode, an electronic liquid powder (registered trademark) mode, or the like; a digital micromirror device (DMD); a plasma display panel (PDP); a field emission display (FED); a surface conduction electron-emitter display (SED); a light-emitting diode (LED) display; a carbon nanotube display; a nanocrystal display; and a quantum dot display.

The portable information terminal 8040 illustrated in FIG. 13A is an example of providing the one display portion 8042 in the housing 8041; however, one embodiment of the present invention is not limited to this example. The display portion 8042 may be provided on a rear surface of the portable information terminal 8040. Further, the portable information terminal 8040 may be a foldable portable information terminal in which two or more display portions are provided.

A touch panel with which data can be input by an instruction means such as a finger or a stylus is provided as an input means on the display portion 8042. Therefore, icons 8044 displayed on the display portion 8042 can be easily operated by the instruction means. Since the touch panel is provided, a region for a keyboard on the portable information terminal 8040 is not needed and thus the display portion can be provided in a large region. Further, since data can be input with a finger or a stylus, a user-friendly interface can be obtained. Although the touch panel may be of any of various types such as a resistive type, a capacitive type, an infrared ray type, an electromagnetic induction type, and a surface acoustic wave type, the resistive type or the capacitive type is particularly preferable because the display portion 8042 can be curved. Furthermore, such a touch panel may be what is called an in-cell touch panel, in which a touch panel is integrated with the display module or the display panel.

The touch panel may also function as an image sensor. In this case, for example, an image of a palm print, a fingerprint, or the like is taken with the display portion 8042 touched with the palm or the finger, whereby personal authentication can be performed. Furthermore, with the use of backlight or a sensing light source emitting near-infrared light for the display portion 8042, an image of a finger vein, a palm vein, or the like can also be taken.

Further, instead of the touch panel, a keyboard may be provided in the display portion 8042. Furthermore, both the touch panel and the keyboard may be provided.

The button 8043 for operation can have various functions in accordance with the intended use. For example, the button 8043 may be used as a home button so that a home screen is displayed on the display portion 8042 by pressing the button 8043. Further, the portable information terminal 8040 may be configured such that main power source thereof is turned off with a press of the button 8043 for a predetermined time. A structure may also be employed in which a press of the button 8043 brings the portable information terminal 8040 which is in a sleep mode out of the sleep mode. Besides, the button can be used as a switch for starting a variety of functions, for example, depending on the length of time for pressing or by pressing the button at the same time as another button.

Further, the button 8043 may be used as a volume control button or a mute button to have a function of adjusting the volume of the speaker 8047 for outputting sound, for example. The speaker 8047 outputs various kinds of sound, examples of which are sound set for predetermined processing, such as startup sound of an operating system (OS), sound from sound files executed in various applications, such as music from music reproduction application software, and an incoming e-mail alert. Although not illustrated, a connector for outputting sound to a device such as headphones, earphones, or a headset may be provided together with or instead of the speaker 8047 for outputting sound.

As described above, the button 8043 can have various functions. Although the number of the button 8043 is two in the portable information terminal 8040 in FIG. 13A, it is needless to say that the number, arrangement, position, or the like of the buttons is not limited to this example and can be determined as appropriate.

The microphone 8046 can be used for sound input and recording. Images obtained with the use of the camera 8045 can be displayed on the display portion 8042.

In addition to the operation with the touch panel provided on the display portion 8042 or the button 8043, the portable information terminal 8040 can be operated by recognition of user's movement (gesture) (also referred to as gesture input) using the camera 8045, a sensor provided in the portable information terminal 8040, or the like. Alternatively, with the use of the microphone 8046, the portable information terminal 8040 can be operated by recognition of user's voice (also referred to as voice input). By introducing a natural user interface (NUI) technique which enables data to be input to an electrical device by natural behavior of a human, the operational performance of the portable information terminal 8040 can be further improved.

The connection terminal 8048 is a terminal for inputting a signal at the time of communication with an external device or inputting electric power at the time of power supply. For example, the connection terminal 8048 can be used for connecting an external memory drive to the portable information terminal 8040. Examples of the external memory drive are storage medium drives such as an external hard disk drive (HDD), a flash memory drive, a digital versatile disc (DVD) drive, a DVD-recordable (DVD-R) drive, a DVD-rewritable (DVD-RW) drive, a compact disc (CD) drive, a compact disc recordable (CD-R) drive, a compact disc rewritable (CD-RW) drive, a magneto-optical (MO) disc drive, a floppy disk drive (FDD), and other nonvolatile solid state drive (SSD) devices. Although the portable information terminal 8040 has the touch panel on the display portion 8042, a keyboard may be provided on the housing 8041 instead of the touch panel or may be externally added.

Although the number of the connection terminal 8048 is one in the portable information terminal 8040 in FIG. 13A, it is needless to say that the number, arrangement, position, or the like of the connection terminals is not limited to this example and can be determined as appropriate.

FIG. 13B is a perspective view illustrating the rear surface and the side surface of the portable information terminal 8040. In the portable information terminal 8040, the housing 8041 includes a solar cell 8049 and a camera 8050 on its rear surface; the portable information terminal 8040 further includes a charge and discharge control circuit 8051, a secondary battery 8052, a DC-DC converter 8053, and the like. FIG. 13B illustrates an example where the charge and discharge control circuit 8051 includes the secondary battery 8052 and the DC-DC converter 8053. The electrochemical device and the method for suppressing deterioration of the electrochemical device, which are embodiments of the present invention described in the above embodiments, can be used for the secondary battery 8052.

The solar cell 8049 attached on the rear surface of the portable information terminal 8040 can supply electric power to the display portion, the touch panel, a video signal processor, and the like. Note that the solar cell 8049 can be provided on one or both surfaces of the housing 8041. By including the solar cell 8049 in the portable information terminal 8040, the secondary battery 8052 in the portable information terminal 8040 can be charged even in a place where an electric power supply unit is not provided, such as outdoors.

As the solar cell 8049, it is possible to use any of the following: a silicon-based solar cell including a single layer or a stacked layer of single crystal silicon, polycrystalline silicon, microcrystalline silicon, or amorphous silicon; an InGaAs-based, GaAs-based, CIS-based, Cu₂ZnSnS₄-based, or CdTe—CdS-based solar cell; a dye-sensitized solar cell including an organic dye; an organic thin film solar cell including a conductive polymer, fullerene, or the like; a quantum dot solar cell having a pin structure in which a quantum dot structure is formed in an i-layer with silicon or the like; and the like.

Here, an example of a structure and operation of the charge and discharge control circuit 8051 illustrated in FIG. 13B is described with reference to a block diagram in FIG. 13C.

FIG. 13C illustrates the solar cell 8049, the secondary battery 8052, the DC-DC converter 8053, a converter 8057, a switch 8054, a switch 8055, a switch 8056, and the display portion 8042. The secondary battery 8052, the DC-DC converter 8053, the converter 8057, and the switches 8054 to 8056 correspond to the charge and discharge control circuit 8051 in FIG. 13B.

The voltage of electric power generated by the solar cell 8049 with the use of external light is raised or lowered by the DC-DC converter 8053 to be at a level needed for charging the secondary battery 8052. When electric power from the solar cell 8049 is used for the operation of the display portion 8042, the switch 8054 is turned on and the voltage of the electric power is raised or lowered by the converter 8057 to a voltage needed for operating the display portion 8042. In addition, when display on the display portion 8042 is not performed, the switch 8054 is turned off and the switch 8055 is turned on so that the secondary battery 8052 may be charged.

Although the solar cell 8049 is described as an example of a power generation means, the power generation means is not particularly limited thereto, and the secondary battery 8052 may be charged by another power generation means such as a piezoelectric element or a thermoelectric conversion element (Peltier element). The charging method of the secondary battery 8052 in the portable information terminal 8040 is not limited thereto, and the connection terminal 8048 may be connected to a power source to perform charge, for example. The secondary battery 8052 may be charged by a non-contact power transmission module which performs charge by transmitting and receiving power wirelessly (without contact), or any of the above charging methods may be used in combination.

Here, the state of charge (SOC) of the secondary battery 8052 is displayed on the upper left corner (in the dashed frame in FIG. 13A) of the display portion 8042. Thus, the user can check the state of charge of the secondary battery 8052 and can accordingly select a power saving mode of the portable information terminal 8040. When the user selects the power saving mode, for example, the button 8043 or the icons 8044 can be operated to switch the components of the portable information terminal 8040, e.g., the display module or the display panel, an arithmetic unit such as CPU, and a memory, to the power saving mode. Specifically, in each of the components, the use frequency of a given function is decreased to stop the use. Further, the portable information terminal 8040 can be configured to be automatically switched to the power saving mode depending on the state of charge. Furthermore, by providing a sensor such as an optical sensor in the portable information terminal 8040, the amount of external light at the time of using the portable information terminal 8040 is sensed to optimize display luminance, which makes it possible to reduce the power consumption of the secondary battery 8052.

In addition, when charging with the use of the solar cell 8049 or the like is performed, an image or the like showing that the charging is performed with the solar cell may be displayed on the upper left corner (in the dashed frame) of the display portion 8042 as illustrated in FIG. 13A.

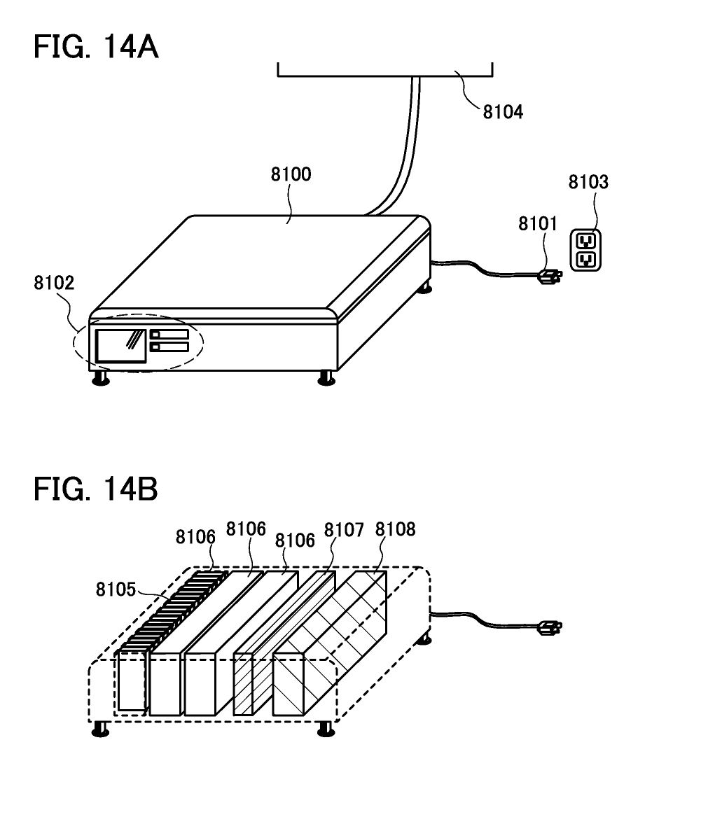

In addition, as another example of the electrical devices, a power storage system is described with reference to FIGS. 14A and 14B. A power storage system 8100 to be described here can be used at home. Here, the power storage system 8100 is described as a home-use power storage system as an example; however, it is not limited thereto and can also be used for business use or other uses.

As illustrated in FIG. 14A, the power storage system 8100 includes a plug 8101 for being electrically connected to a system power supply 8103. The power storage system 8100 is electrically connected to a panelboard 8104 installed in home.

The power storage system 8100 may further include a display panel 8102 for displaying an operation state or the like, for example. The display panel may have a touch screen. In addition, the power storage system 8100 may include a switch for turning on and off a main power source, a switch to operate the power storage system, and the like as well as the display panel.

Although not illustrated, an operation switch to operate the power storage system 8100 may be provided separately from the power storage system 8100; for example, the operation switch may be provided on a wall in a room. Alternatively, the power storage system 8100 may be connected to a personal computer, a server, or the like provided in home, in order to be operated indirectly. Still alternatively, the power storage system 8100 may be remotely operated using the Internet, an information terminal such as a smartphone, or the like. In such cases, a mechanism that performs wired or wireless communication between the power storage system 8100 and other devices is provided in the power storage system 8100.

FIG. 14B is a schematic view illustrating the inside of the power storage system 8100. The power storage system 8100 includes a plurality of secondary battery groups 8106, a battery management unit (BMU) 8107, and a power conditioning system (PCS) 8108.

In the secondary battery group 8106, a plurality of secondary batteries 8105 are connected to each other. Electric power from the system power supply 8103 can be stored in the secondary battery groups 8106. The plurality of secondary battery groups 8106 are each electrically connected to the BMU 8107.

The BMU 8107 has functions of monitoring and controlling states of the plurality of secondary batteries 8105 included in the secondary battery groups 8106 and protecting the secondary batteries 8105. Specifically, the BMU 8107 collects data of cell voltages and cell temperatures of the plurality of secondary batteries 8105 in the secondary battery groups 8106, monitors overcharge and overdischarge, monitors overcurrent, controls a cell balancer, manages the deterioration condition of a battery, calculates the remaining battery level (the state of charge (SOC)), controls a cooling fan of a driving secondary battery, or controls detection of failure, for example. Note that the secondary batteries 8105 may have some of or all the functions, or the secondary battery groups may have the functions. The BMU 8107 is electrically connected to the PCS 8108.

Overcharge means that charge is further performed in a state of full charge, and overdischarge means that discharge is further performed to the extent that the capacity is reduced so that operation becomes impossible. Overcharge can be prevented by monitoring the voltage of a secondary battery during charge so that the voltage does not exceed a specified value (allowable value), for example. Overdischarge can be prevented by monitoring the voltage of a secondary battery during discharge so that the voltage does not become lower than a specified value (allowable value).

Overcurrent refers to a current exceeding a specified value (allowable value). Overcurrent of a secondary battery is caused when a positive electrode and a negative electrode are short-circuited in the secondary battery or the secondary battery is under an extremely heavy load, for example. Overcurrent can be prevented by monitoring a current flowing through the secondary battery.

The PCS 8108 is electrically connected to the system power supply 8103, which is an AC power source and performs DC-AC conversion. For example, the PCS 8108 includes an inverter, a system interconnection protective device that detects irregularity of the system power supply 8103 and terminates its operation, and the like. In charging the power storage system 8100, for example, AC power from the system power supply 8103 is converted into DC power and transmitted to the BMU 8107. In discharging the power storage system 8100, electric power stored in the secondary battery groups 8106 is converted into AC power and supplied to an indoor load, for example. Note that the electric power may be supplied from the power storage system 8100 to the load through the panelboard 8104 as illustrated in FIG. 14A or may be directly supplied from the power storage system 8100 through wired or wireless transmission.

Note that a power source for charging the power storage system 8100 is not limited to the system power supply 8103 described above; for example, electric power may be supplied from a solar power generating system installed outside.

This embodiment can be freely combined with any of the other embodiments.

### Example

In this example, an electrochemical device to which an inversion pulse current is applied in charging is described in detail. In this example, coin-type lithium-ion secondary batteries were fabricated and subjected to a charging test. In the fabricated secondary batteries, lithium salts in electrolytic solutions have different concentrations. Among the batteries subjected to the charging test, hereinafter, the battery in which the concentration of the lithium salt in the electrolytic solution is 0.25 M is referred to as Evaluation Cell 1, the battery in which the concentration of the lithium salt in the electrolytic solution is 0.5 M is referred to as Evaluation Cell 2, the battery in which the concentration of the lithium salt in the electrolytic solution is 1.0 M is referred to as Evaluation Cell 3, and the battery in which the concentration of the lithium salt in the electrolytic solution is 2.0 M is referred to as Evaluation Cell 4.

### <Fabrication of Evaluation Cells 1 to 4>

### (Formation of Positive Electrode)

A step of forming a positive electrode is common to Evaluation Cells 1 to 4. First, lithium iron phosphate (LiFePO₄) whose surface was provided with a carbon layer and N-methyl-2-pyrrolidone (NMP) as a polar solvent were stirred and mixed in a mixer at 2000 rpm for 5 minutes.

Acetylene black (AB) was added to this mixture, and the mixture was stirred and mixed in the mixer at 2000 rpm for 5 minutes. Further, after NMP was added to the mixture to adjust the viscosity, the mixture was stirred and mixed in the mixer at 2000 rpm for 5 minutes. The lithium iron phosphate, the AB, and the PVDF were weighed and adjusted so that the weight ratio thereof (excluding the polar solvent) is 83:8:9.

The mixture formed in such a manner was applied onto aluminum foil with the use of an applicator. This was dried in hot air at 135° C. for 2 hours or longer to volatilize the polar solvent, and then pressed to compress an active material layer; thus, an electrode was formed. The electrode was stamped into the positive electrodes of Evaluation Cells 1 to 4.

### (Formation of Negative Electrode)

A step of forming a negative electrode is common to Evaluation Cells 1 to 4. First, AB and PVDF were stirred and mixed in a mixer at 2000 rpm for 10 minutes.

Graphite particles with an average particle diameter of 9 μm were added to the mixture, and then the mixture was stirred and mixed in the mixer at 2000 rpm for 10 minutes. Further, after NMP was added to the mixture to adjust the viscosity, the mixture was stirred and mixed in the mixer at 2000 rpm for 10 minutes. The graphite particles, the AB, and the PVDF were weighed and adjusted so that the weight ratio thereof (excluding the polar solvent) is 93:2:5.

The mixture formed in such a manner was applied onto copper foil with the use of an applicator. This was dried to volatilize the polar solvent, and then pressed to compress an active material layer; thus, an electrode was formed. The electrode was stamped into the negative electrodes of Evaluation Cells 1 to 4.

### (Electrolytic Solution)

Evaluation Cells 1 to 4 vary in the concentration of a lithium salt in an electrolytic solution.

In Evaluation Cell 1, the electrolytic solution was formed in such a manner that lithium hexafluorophosphate (LiPF₆) was dissolved at a concentration of 0.25 M in a solution in which ethylene carbonate (EC) and diethyl carbonate (DEC) were mixed in a volume ratio of 3:7.

In Evaluation Cell 2, the electrolytic solution was formed in such a manner that LiPF₆ was dissolved at a concentration of 0.5 M in a solution in which EC and DEC were mixed in a volume ratio of 3:7.

In Evaluation Cell 3, the electrolytic solution was formed in such a manner that LiPF₆ was dissolved at a concentration of 1.0 M in a solution in which EC and DEC were mixed in a volume ratio of 3:7.

In Evaluation Cell 4, the electrolytic solution was formed in such a manner that LiPF₆ was dissolved at a concentration of 2.0 M in a solution in which EC and DEC were mixed at a volume ratio of 3:7.

### (Fabrication of Evaluation Cells 1 to 4)

Evaluation Cells 1 to 4 were fabricated using the positive electrodes, the negative electrodes, and the electrolytic solutions formed in the above manner. Evaluation Cells 1 to 4 were each fabricated as a CR2032 coin-cell battery (with a diameter of 20 mm and a height of 3.2 mm) A 260-μm-thick glass fiber separator (GF/C) was used as each separator.

### (Detailed Description of Positive Electrodes, Negative Electrodes, and Electrolytic Solutions)

Thicknesses of the positive electrodes and the negative electrodes, the densities of the electrodes, the active material contents in the electrodes, and capacity ratios of Evaluation Cells 1 to 4 fabricated in the above process are as follows.

TABLE 1

| | | Evaluation | Evaluation | Evaluation | Evaluation | Evaluation | Evaluation | Evaluation |
|---|---|---|---|---|---|---|---|---|
| | Cell | Cell 1(A) | Cell 1(B) | Cell 2(A) | Cell 2(B) | Cell 3(A) | Cell 3(B) | Cell 4 |
| Positive electrode | Thickness | 115 | 116 | 113 | 111 | 110 | 111 | 110 |
| | [μm] | | | | | | | |
| | Density of | 1.42 | 1.42 | 1.45 | 1.47 | 1.41 | 1.39 | 1.44 |
| | electrode | | | | | | | |
| | [g/cm³] | | | | | | | |
| | Active | 13.5 | 13.7 | 13.6 | 13.6 | 12.9 | 12.8 | 13.2 |
| | material | | | | | | | |
| | content in | | | | | | | |
| | electrode | | | | | | | |
| | [g/cm²] | | | | | | | |
| Negative electrode | Thickness | 69 | 68 | 73 | 73 | 71 | 61 | 79 |
| | [μm] | | | | | | | |
| | Density of | 0.99 | 1.02 | 0.94 | 0.94 | 0.92 | 1.06 | 0.85 |
| | electrode | | | | | | | |
| | [g/cm³] | | | | | | | |
| | Active | 6.4 | 6.4 | 6.4 | 6.4 | 6.1 | 6.0 | 6.2 |
| | material | | | | | | | |
| | content in | | | | | | | |
| | electrode | | | | | | | |
| | [g/cm²] | | | | | | | |
| | Capacity ratio | 94.7 | 94.6 | 95.0 | 95.0 | 94.7 | 95.1 | 94.5 |
| | [%] | | | | | | | |
| Electrolytic | Concentration | 0.25M | | 0.5M | | 1.0M | | 2.0M |
| solution | | | | | | | | |
| Inversion | Application | Made | Not made | Made | Not made | Made | Not made | Not made |
| pulse | | | | | | | | |
| current | | | | | | | | |

Note that in Table 1, there are two kinds, “A” and “B”, of Evaluation Cells 1 to 3 to check whether the dissolution of lithium depends on application of the inversion pulse current. In Table 1, “A” indicates a cell to which the inversion pulse current was applied and “B” indicates a cell to which the inversion pulse current was not applied. That is, the inversion pulse current was applied during the charging period of Evaluation Cell 1(A), Evaluation Cell 2(A), and Evaluation Cell 3 (A), and the inversion pulse current was not applied during the charging period of Evaluation Cell 1(B), Evaluation Cell 2(B), Evaluation Cell 3(B), and Evaluation Cell 4.

### <Whether to Apply Inversion Pulse Current to Evaluation Cells>

Whether lithium deposits were dissolved in Evaluation Cells 1 to 4 was checked in the case of applying the inversion pulse current and the case of not applying the inversion pulse current.

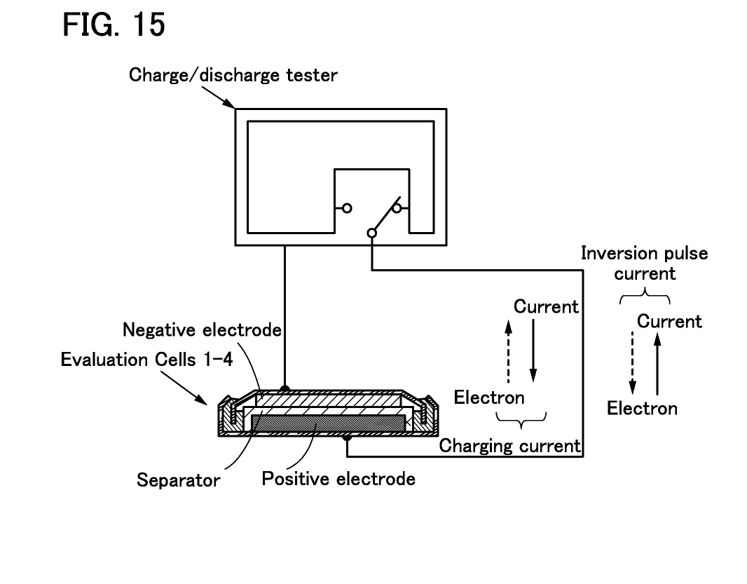

First, initial charging was performed without applying an inversion pulse current. Next, discharging was performed. Then, second charging was performed. The initial charging, the discharging, and the second charging were performed by connecting each of Evaluation Cells 2(A), 2(B), 3(A), and 3(B) to a charge/discharge tester as illustrated in FIG. 15. Note that the environmental temperature was 25° C.

Note that in the second charging period, the inversion pulse current was applied to Evaluation Cell 2(A) and Evaluation Cell 3(A) more than once. In the second charging period, the inversion pulse current was not applied to Evaluation Cell 2(B) and Evaluation Cell 3(B).

Further, 1 C, which means the amount of current with which the total capacity of each of Evaluation Cells 1 to 4 is discharged in an hour, was calculated from the weight of the positive electrode active material (17.613 mg) and the theoretical capacity of LiFePO₄ (170 mAh/g). The charge rate and the discharge rate (unit: C) of Evaluations Cell 1 to 4 were set relative to 1 C.

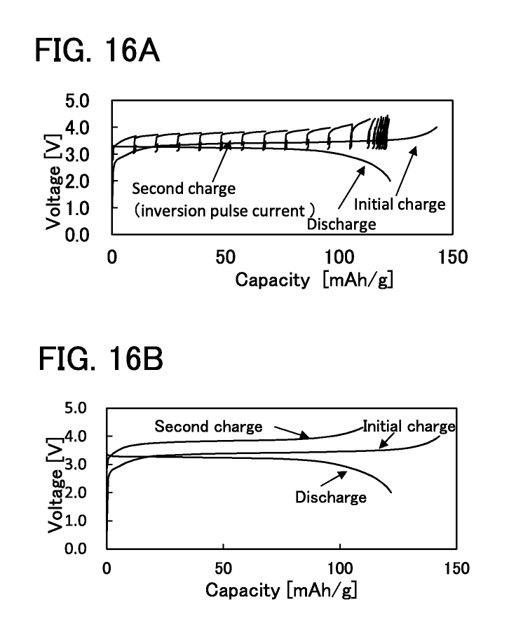

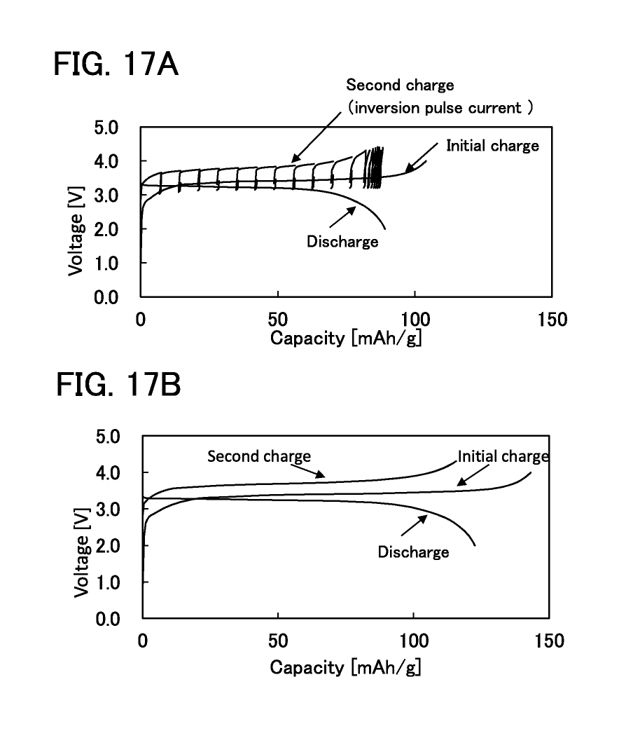

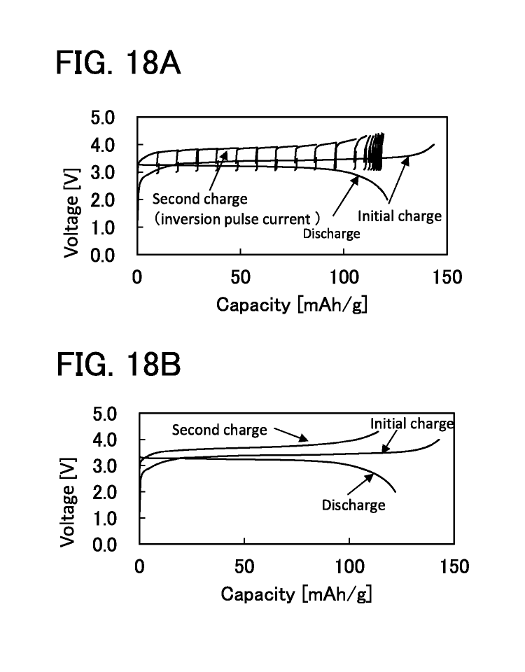

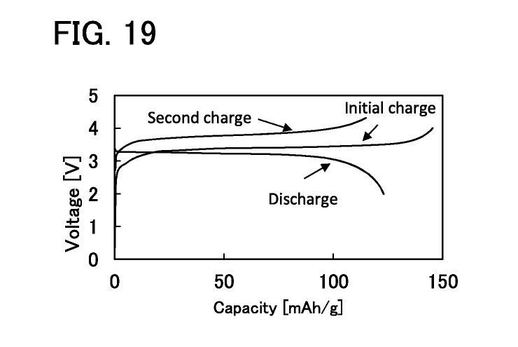

FIG. 16A shows a change in a voltage (cell voltage) to the capacity (battery capacity) of Evaluation Cell 1(A). FIG. 16B shows a change in a voltage (cell voltage) to the capacity (battery capacity) of Evaluation Cell 1(B). FIG. 17A shows a change in a voltage (cell voltage) to the capacity (battery capacity) of Evaluation Cell 2(A). FIG. 17B shows a change in a voltage (cell voltage) to the capacity (battery capacity) of Evaluation Cell 2(B). FIG. 18A shows a change in a voltage (cell voltage) to the capacity (battery capacity) of Evaluation Cell 3(A). FIG. 18B shows a change in a voltage (cell voltage) to the capacity (battery capacity) of Evaluation Cell 3(B). FIG. 19 shows a change in a voltage (cell voltage) to the capacity (battery capacity) of Evaluation Cell 4.

There are three curves in FIG. 16A. One curve shows an increase in the capacity during the initial charging. Another curve shows a decrease in the capacity during the discharging. The other curve shows an increase in the capacity during the second charging in which the charging current and the inversion pulse current were alternately applied more than once. Note that in the graphs in FIG. 17A and FIG. 18A, a change in a voltage to the capacity of the evaluation cell is shown in a manner similar to the above.

There are three curves in FIG. 16B, as in FIG. 16A. One curve shows an increase in the capacity during the initial charging. Another curve shows a decrease in the capacity during the discharging. The other curve shows an increase in the capacity during the second charging. Note that in the graphs in FIG. 17B, FIG. 18B, and FIG. 19, a change in a voltage to the capacity of the evaluation cell is shown in a manner similar to the above.

In each of FIGS. 16A and 16B, FIGS. 17A and 17B, FIGS. 18A and 18B, and FIG. 19, the initial charging was performed at 0.2 C. The charging was stopped when the cell voltage reached 4.0 V.

In each of FIGS. 16A and 16B, FIGS. 17A and 17B, FIGS. 18A and 18B, and FIG. 19, the discharging was performed at 0.2 C. The discharging was stopped when the cell voltage decreased to 2.0 V.

In each of FIG. 16A, FIG. 17A, and FIG. 18A, the second charging was performed by alternately applying the charging current and the inversion pulse current. The second charging was performed at high rate, that is, the second charging was rapid charging. Specifically, the charging current was applied to each of Evaluation Cells 1(A), 2(A), and 3(A) at 2 C to obtain a capacity of 10 mAh/g, and then the inversion pulse current was applied to each of Evaluation Cells 1(A), 2(A), and 3(A) at 1 C for 20 seconds. Then, the second charging was stopped when the cell voltage reached 4.3 V.

In each of FIG. 16B, FIG. 17B, FIG. 18B, and FIG. 19, the second charging was performed at 0.2 C. The second charging was stopped when the cell voltage reached 4.3 V.

### <Observation of Negative Electrode>

After the second charging, Evaluation Cells 1 to 4 were each disassembled in a glove box in an argon atmosphere, and the negative electrode was taken out of each of Evaluation Cells 1 to 4 and washed with dimethyl carbonate. Then, the negative electrode was carried into a scanning electron microscope (SEM) using an atmosphere barrier holder and the surface of the negative electrode was observed.

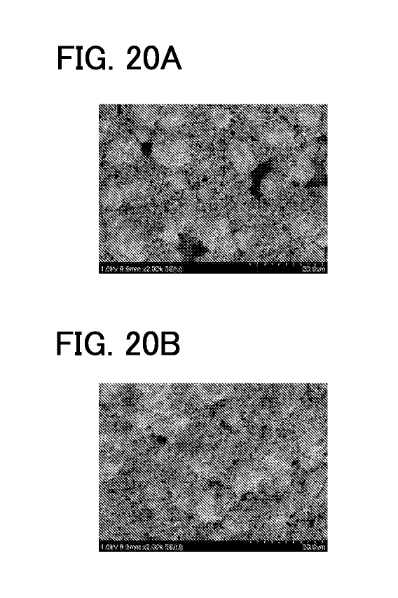

FIGS. 20A and 20B show secondary electron images of surfaces of the negative electrodes in Evaluation Cell 1(A) and Evaluation Cell 1(B) observed with the SEM. Spherical substances in FIGS. 20A and 20B are graphite used as the negative electrode active material. FIG. 20A shows the surface of the negative electrode in the evaluation cell charged by alternately applying the charging current and the inversion pulse current; FIG. 20B shows the surface of the negative electrode in the evaluation cell charged without application of the inversion pulse current. Whisker-like reaction products that cover the surfaces of the graphite are observed in both of FIGS. 20A and 20B. In FIG. 20A showing the surface of the negative electrode in the evaluation cell charged by alternately applying the charging current and the inversion pulse current, the number of whisker-like reaction products is less than that in FIG. 20B showing the surface of the negative electrode in the evaluation cell charged without application of the inversion pulse current. The reduction in the number of whisker-like reaction products indicates that lithium whiskers can be dissolved by alternately applying the charging current and the inversion pulse current.

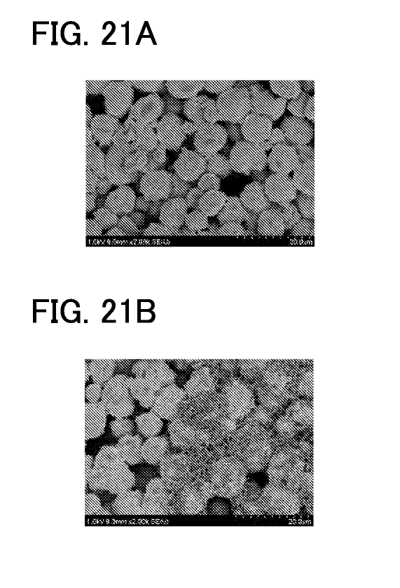

As FIGS. 20A and 20B, FIGS. 21A and 21B show secondary electron images of surfaces of the negative electrodes in Evaluation Cell 2(A) and Evaluation Cell 2(B) observed with the SEM. Spherical substances in FIGS. 21A and 21B are graphite used as the negative electrode active material. There are no whisker-like reaction product on a surface of the graphite in FIG. 21A showing the surface of the negative electrode in the evaluation cell charged by alternately applying the charging current and the inversion pulse current. On the other hand, whisker-like reaction products that cover a surface of the graphite are observed in FIG. 21B showing the surface of the negative electrode in the evaluation cell charged without application of the inversion pulse current. The presence and the absence of the whisker-like reaction products indicate that lithium whiskers can be dissolved by alternately applying the charging current and the inversion pulse current.

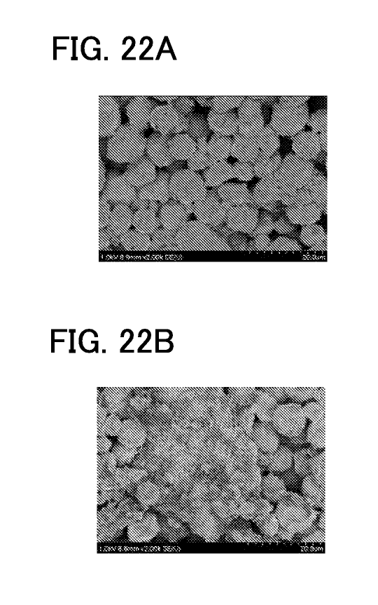

FIGS. 22A and 22B show secondary electron images of surfaces of the negative electrodes in Evaluation Cell 3(A) and Evaluation Cell 3(B) observed with the SEM. Spherical substances in FIGS. 22A and 22B are graphite used as the negative electrode active material. There are no whisker-like reaction product on a surface of the graphite in FIG. 22A showing the surface of the negative electrode in the evaluation cell charged by alternately applying the charging current and the inversion pulse current. On the other hand, whisker-like reaction products that cover a surface of the graphite are observed in FIG. 22B showing the surface of the negative electrode in the evaluation cell charged without application of the inversion pulse current. The presence and the absence of the whisker-like reaction products indicate that lithium whiskers can be dissolved by alternately applying the charging current and the inversion pulse current.

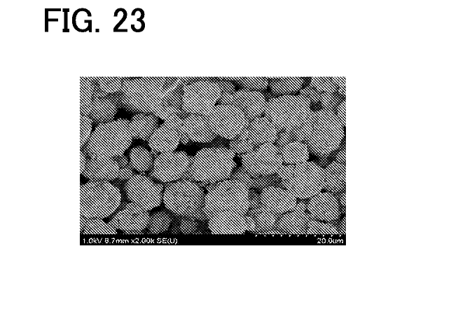

FIG. 23 shows a secondary electron image of the surface of the negative electrode in Evaluation Cell 4 observed with the SEM. The spherical substances in FIG. 23 are graphite used as the negative electrode active material. In FIG. 23, whisker-like reaction products are not observed on a surface of the graphite. This suggests that there is no need to apply the charging current and the inversion pulse current alternately in the case where the concentration of a lithium salt in an electrolytic solution is higher than 1.0 M.

The results in this example show that lithium deposition on a negative electrode surface can be inhibited and lithium deposited on the negative electrode surface can be dissolved even when the concentration of a lithium salt in an electrolytic solution is lower than 1.0 M. Thus, a positive electrode and a negative electrode are inhibited from being short-circuited and lithium can be inhibited from being separated in the negative electrode. Further, the concentration of the lithium salt in the electrolytic solution can be lowered to the concentration with which lithium deposition occurs in the negative electrode; therefore, the amount of solute dissolved in the electrolytic solution can be reduced and the viscosity of the electrolytic solution can be decreased.

### <<Mechanism of Lithium Deposition>>

Here, with the use of schematic diagrams, description is given of a mechanism that is intended to represent the phenomenon of lithium deposition on a surface of graphite described in this example.

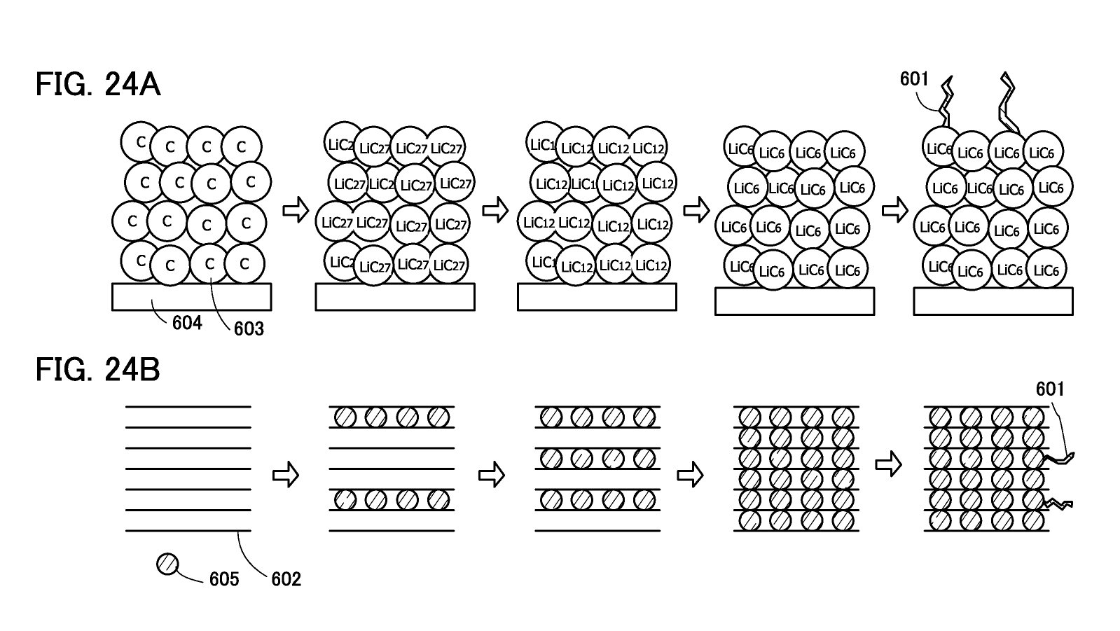

Intercalation of lithium into graphite in charging can be described with reference to the schematic diagrams in FIGS. 24A and 24B.

FIG. 24A illustrates schematic diagrams of particulate graphite 603 stacked over a current collector 604. The schematic diagrams are simplified diagrams of lithium intercalation into the graphite 603 which is promoted by charging.

In FIG. 24A, intercalation is promoted due to migration of lithium caused by charging, so that the state of the graphite 603 is changed from “C” in which there is no lithium intercalation into “LiC₂₇” in which lithium is intercalated into part of the graphite 603. Next, in FIG. 24A, the intercalation is promoted due to migration of lithium caused by charging, so that the state of the graphite 603 is changed from “LiC₂₇” in which lithium is intercalated into part of the graphite 603 into “LiC₁₂” in which lithium is further intercalated. Then, in FIG. 24A, the intercalation is promoted due to migration of lithium caused by charging, so that the state of the graphite 603 is changed from “LiC₁₂” in which lithium is further intercalated into “LiC₆” in which the graphite 603 is filled with lithium. Furthermore, in FIG. 24A, due to migration of lithium caused by charging, the state of the graphite 603 is changed from “LiC₆” in which the graphite 603 is filled with lithium into a state in which lithium overflows to cause deposition of lithium 601.

Note that the compositions and the like of lithium and graphite used in the description of FIG. 24A are examples used to describe a change in the states in charging. For this reason, lithium might be deposited even when the graphite 603 is in the state of “LiC₁₂” or “LiC₂₇” which is before “LiC₆”.

FIG. 24B illustrates schematic diagrams of intercalation of lithium 605 into a space between carbon hexagonal net surfaces 602 in graphite, which corresponds to the schematic diagrams in FIG. 24A.

In FIG. 24B, due to migration of lithium caused by charging, lithium 605 is intercalated into spaces between the carbon hexagonal net surfaces 602 in the graphite. Next, in FIG. 24B, due to migration of lithium caused by charging, the lithium 605 is further intercalated into the spaces between the carbon hexagonal net surfaces 602 in the graphite. Then, in FIG. 24B, due to migration of lithium caused by charging, the spaces between the carbon hexagonal net surfaces 602 in the graphite are filled with the lithium 605. Furthermore, in FIG. 24B, the lithium 605 filling the spaces between the carbon hexagonal net surfaces 602 in the graphite overflows to cause deposition of the lithium 601.

Note that although the scale of the lithium whiskers is similar to that of the lithium ions in FIG. 24B, the lithium whiskers grow large in practice.

In FIGS. 24A and 24B, description is given on the assumption that the lithium intercalation due to charging occurs evenly in the graphite. To promote the lithium intercalation into the graphite evenly, lithium needs to be supplied from the electrolytic solution one after another. It is likely that supply of lithium from the electrolytic solution is not enough when the concentration of the lithium salt in the electrolytic solution is lower than 1.0 M, so that lithium is intercalated into graphite unevenly.

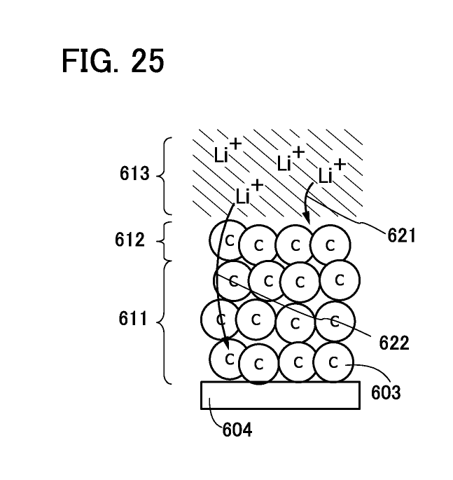

FIG. 25 schematically illustrates an inside 611 and a surface 612 of a negative electrode into which lithium is intercalated and an electrolytic solution 613.

In FIG. 25, in the electrode formed of the porous graphite 603, lithium ions in the electrolytic solution 613 can immediately reach the surface 612 (indicated by an arrow 621 in FIG. 25); however, arrival of the lithium ions to the inside 611 (indicated by an arrow 622 in FIG. 25) is delayed because a path for the electrolytic solution is narrow. For this reason, supply of lithium into graphite on the surface 612 and supply of lithium into graphite in the inside 611 are different in speed. In particular, there is probably a big difference in the speed during rapid charging.

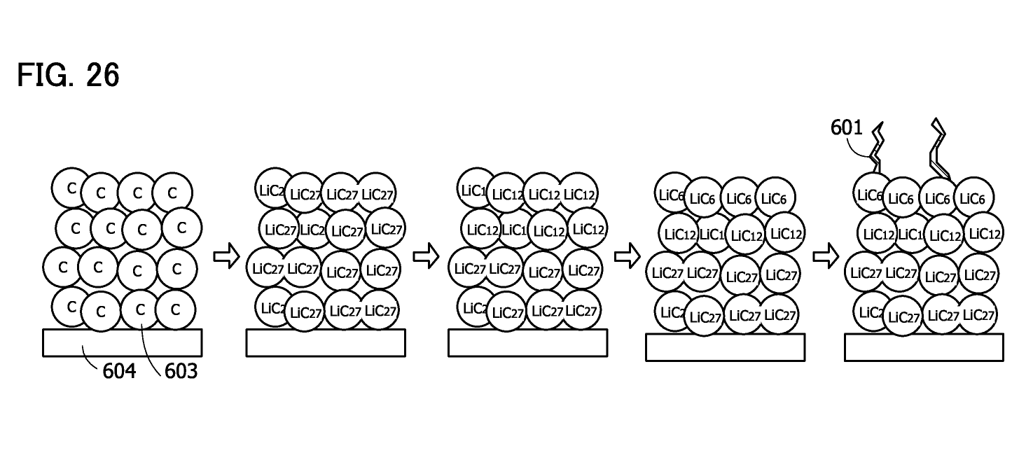

FIG. 26 illustrates schematic diagrams of the particulate graphite 603 stacked over the current collector 604 like FIG. 24A. With reference to FIG. 26, description is given on the assumption that supply of lithium into the graphite 603 on the electrode surface and supply of lithium into the graphite 603 in the inside of the electrode are different in speed, which is different from the case of FIG. 24A.

In FIG. 26, intercalation is promoted due to migration of lithium caused by charging, so that the state of the graphite 603 is changed from “C” in which there is no lithium intercalation into “LiC₂₇” in which lithium is intercalated into part of the graphite 603.

Next, in FIG. 26, supply of lithium into the graphite 603 on the electrode surface is assumed different from supply of lithium into the graphite 603 in the inside of the electrode in speed. In such a case, lithium intercalation is promoted on the electrode surface so that the state of the graphite on the electrode surface is changed into “LiC₁₂” in which lithium is further intercalated, and the state of the graphite in the inside of the electrode remains in the state of “LiC₂₇” because lithium intercalation is less promoted in the inside of the electrode.

In the case where there remains a difference in the speed of supply of lithium to the graphite 603 on the electrode surface and the speed of supply of lithium to the graphite 603 in the inside of the electrode, when supply of lithium due to charging proceeds, intercalation is promoted on the electrode surface, so that the state of the graphite on the electrode surface is changed into “LiC₆” in which the graphite 603 is filled with lithium; whereas, the intercalation is less promoted in the inside of the electrode, so that the state of the graphite in the inside of the electrode remains “LiC₁₂” or “LiC₂₇”. Furthermore, in FIG. 26, when supply of lithium due to charging proceeds, the state of the graphite 603 on the electrode surface is changed into the state in which lithium overflows to cause deposition of the lithium 601. On the other hand, the state of the graphite in the inside of the electrode remains “LiC₁₂” or “LiC₂₇” because the lithium intercalation does not proceed.

Next, whether lithium deposition actually occurs only on an electrode surface was checked by observation of a cross section of an electrode in which lithium whiskers are deposited.

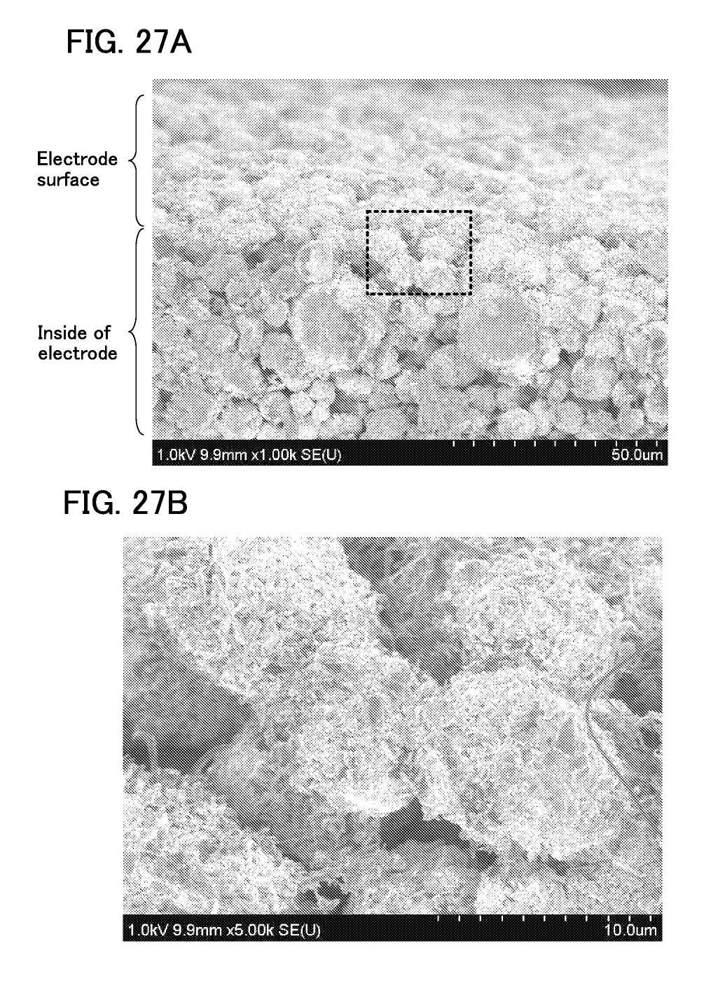

FIG. 27A shows a SEM image of a cross section of an electrode. FIG. 27B shows an enlarged image of a region surrounded by a dotted line in FIG. 27A. FIGS. 27A and 27B show that lithium whiskers are observed only in the vicinity of a surface of the electrode. On the other hand, lithium whiskers are not observed in the inside of the electrode.

As described above, it is found that lithium is easily deposited in the case where lithium intercalation due to charging occurs unevenly in graphite. Lithium intercalation occurs unevenly in the case where the concentration of a lithium salt in an electrolytic solution is lower than 1.0 M or the case where arrival of lithium ions at an electrode surface and arrival of lithium ions at an inside of the electrode are different in speed at the time of rapid charging. Even in the case where the lithium deposition is likely to occur, lithium deposition can be inhibited and lithium whiskers can be dissolved with the use of the technical idea of alternately applying the charging current and the inversion pulse current.

This application is based on Japanese Patent Application serial no. 2013-069618 filed with Japan Patent Office on Mar. 28, 2013, the entire contents of which are hereby incorporated by reference.

What is claimed is:

1. An electrochemical device comprising:
a first electrode;
a second electrode; and
an electrolytic solution between the first electrode and the second electrode,
wherein a concentration of a lithium salt dissolved in the electrolytic solution is lower than 1.0 M,
wherein a first current that flows from the second electrode to the first electrode is applied,
wherein a second current that flows from the first electrode to the second electrode is applied after the first current is applied, and
wherein a period in which the second current is applied is shorter than a period in which the first current is applied.

2. The electrochemical device according to claim 1, wherein the lithium salt is lithium hexafluorophosphate.

3. The electrochemical device according to claim 1, wherein the electrolytic solution is a solution in which ethylene carbonate and diethyl carbonate are mixed in a volume ratio of 3:7.

4. The electrochemical device according to claim 1, wherein the first electrode comprises lithium iron phosphate as an active material.

5. The electrochemical device according to claim 1, wherein the second electrode comprises graphite as an active material.

6. The electrochemical device according to claim 1, wherein the concentration of the lithium salt in the electrolytic solution is higher than 0.25 M and lower than 1.0 M.

7. The electrochemical device according to claim 1, wherein the electrochemical device is a lithium-ion secondary battery.

8. The electrochemical device according to claim 1, wherein the second current is applied more than once.

9. An electrochemical device comprising:
a first electrode;
a second electrode; and
an electrolytic solution between the first electrode and the second electrode,
wherein a concentration of a lithium salt dissolved in the electrolytic solution is lower than 1.0 M,
wherein a first current that flows from the second electrode to the first electrode and a second current that flows in a direction opposite to a direction in which the first current flows are alternately applied, and
wherein a period in which the second current is applied is shorter than a period in which the first current is applied.

10. The electrochemical device according to claim 9, wherein the lithium salt is lithium hexafluorophosphate.

11. The electrochemical device according to claim 9, wherein the electrolytic solution is a solution in which ethylene carbonate and diethyl carbonate are mixed in a volume ratio of 3:7.

12. The electrochemical device according to claim 9, wherein the first electrode comprises lithium iron phosphate as an active material.

13. The electrochemical device according to claim 9, wherein the second electrode comprises graphite as an active material.

14. The electrochemical device according to claim 9, wherein the concentration of the lithium salt in the electrolytic solution is higher than 0.25 M and lower than 1.0 M.

15. The electrochemical device according to claim 9, wherein the electrochemical device is a lithium-ion secondary battery.

16. The electrochemical device according to claim 9, wherein the second current is applied more than once.
